(19) United States
(12) Patent Application Publication
(10) Pub. No.: US 2024/0323683 A1
(43) Pub. Date: Sep. 26, 2024

(54) REFRESHING AUTHENTICATION KEYS FOR PROXIMITY BASED SERVICES

(71) Applicant: ZTE Corporation, Shenzhen (CN)

(72) Inventors: Yuze LIU, Shenzhen (CN); Shilin YOU, Shenzhen (CN); Zhen XING, Shenzhen (CN); Zhaoji LIN, Shenzhen (CN); Jigang WANG, Shenzhen (CN)

(21) Appl. No.: 18/679,928

(22) Filed: May 31, 2024

Related U.S. Application Data
(63) Continuation of application No. PCT/CN2022/099896, filed on Jun. 20, 2022.

(51) Int. Cl. H04W 12/06; H04W 12/041

(52) U.S. Cl. CPC H04W 12/06; H04W 12/041

(57) ABSTRACT

Disclosed are techniques for refreshing and updating user keys and user key lifetimes in a wireless communication system. In one aspect, a method of wireless communication is disclosed. The method includes generating, by an authentication node, a remote user key and a remote user key lifetime. The method further includes sending, from the authentication node to an anchor function node, the remote user key and the remote user key lifetime, and sending the remote user key lifetime to a remote wireless device via a relay wireless device.

### CROSS-REFERENCE TO RELATED APPLICATION

This application is a continuation and claims priority to International Application No. PCT/CN2022/099896, filed on Jun. 20, 2022, the disclosure of which is hereby incorporated by reference herein in its entirety.

### TECHNICAL FIELD

This patent document is directed to wireless communications.

### BACKGROUND

3GPP systems require authorizing a user equipment to access a 5G core network (5GC). Without a proper authorization, unauthorized entities will be able to access the 5GC via a relay creating a vulnerability and causing possible denial of service attacks or leading to unauthorized service usage. New security techniques are needed to ensure proper network functioning.

### SUMMARY

Disclosed are techniques for refreshing and updating user keys and user key lifetimes in a wireless communication system. In one aspect, a method of wireless communication is disclosed. The method includes generating, by an authentication node, a remote user key and a remote user key lifetime. The method further includes sending, from the authentication node to an anchor function node, the remote user key and the remote user key lifetime, and sending the remote user key lifetime to a remote wireless device via a relay wireless device.

In another aspect, another method of wireless communication is disclosed. The method includes determining, at an authentication node, to refresh a remote user key using the subscription permanent identifier, and determining to refresh the remote user key based on a policy local to the authentication node.

In yet another aspect, another method of wireless communication is disclosed. The method includes receiving, at an anchor node function from an authentication node, a key request for a remote user key including a identifier of the remote user key. The method further includes determining, at the anchor node function, to refresh the remote user key which is retrieved using the identifier of the remote user key, and sending a subscription permanent identifier and a refresh indication to the authentication node.

In yet another aspect, another method of wireless communication is disclosed. The method includes receiving, at an authentication node, a remote user key, and determining, at the authentication node, to generate a new remote user key based on the received remote user key. The method further includes registering the new remote user key based on the remote user key, and sending, a key refresh indication container to a remote wireless device.

In yet another aspect, another method of wireless communication is disclosed. The method includes receiving, at an anchor node function, a key request for a remote user key including a remote user key identifier. The method further includes determining to generate a new remote user key based on the remote user key, and sending a key refresh indication container to an authentication node and to a remote wireless device.

In yet another aspect, another method of wireless communication is disclosed. The method includes receiving an authentication response message from a management node based in part on an authentication status stored at the management node, and determining, by the first authentication node to refresh a remote user key based in part on a received subscription identifier. The method further includes sending, by the first authentication node to the management node, a request message indicating a result and a time of an authentication procedure with a wireless device using and including a subscription identifier, a timestamp of the authentication, an authentication type and a serving network name. The method includes sending from the first authentication node to a second authentication node, a request message and receiving a response message, and generating, by the first authentication node, the remote user key based on an authentication key.

In yet another aspect, another method of wireless communication is disclosed. The method includes storing, at a management node, an authentication response message based in part on an authentication status. The method further includes receiving a request message based in part on a determination by an anchor function node to refresh a remote user key, and using a subscription identifier to determine a stored identifier at a first authentication node and sending a corresponding request to a second authentication node or to an anchor function node.

### BRIEF DESCRIPTION OF THE DRAWINGS

FIG. 1 shows an example network architecture;

FIG. 2 shows an example of a security procedure over a control plane;

FIG. 3 shows an example of a signaling diagram for setting a lifetime of a key;

FIG. 4 shows an example of a signaling diagram to refresh a user key;

FIG. 5 shows an example of a signaling diagram for refreshing a key based on a determination to do so by the anchor function node;

FIG. 6 shows an example of a signaling diagram for generating a new key based on a previous key;

FIG. 7 shows another example of a signaling diagram for generating a new key based on a previous key;

FIG. 8 shows another example of a signaling diagram for generating a new key based on a previous key;

FIG. 9 shows an example of a signaling diagram for refreshing a key based on a determination of an authentication node;

FIG. 10 shows an example of a signaling diagram for refreshing a key based in a determination by an anchor function node;

FIG. 11 shows an example of a process;

FIG. 12 shows an example of an apparatus; and

FIG. 13 shows an example of a system.

### DETAILED DESCRIPTION

Section headings are used in the present document to improve readability and do not limit scope of the disclosed embodiments and techniques in each section to only that section. Certain features are described using 3GPP terminology but may be practices in other wireless systems that use other wireless communication protocols.

Cellular and other wireless systems require authorizing a user equipment (UE) to access a network such as a 5G core network (5GC) via a 5G UE-to-network relay and to authorize a UE to perform as a UE-to-network relay. Without a proper authorization, unauthorized entities will be able to access 5GC via the UE-to-network relay or act as UE-to-network relays creating a vulnerability and causing possible distributed denial of service (DDOS) attacks or leading to unauthorized service usage on both the 5G system (5GS) and the UE-to-network relay.

Security procedures can be used to protect a network such as a 5G cellular network and associated elements. For example, 5G security procedures over the user plane and over the control plane is described in standards documents including TR 33.503 clause 6.3.3.2 and clause 6.3.3.3. In the clause 6.3.3.2, user plane solution for a proximity-based service (ProSe or Prose) UE-to-network relay, if the 5G ProSe UE-to-network relay's authorization information is not locally available, the 5G Prose Key Management Function (PKMF) can request the authorization information from a unified data management (UDM) node. For the 5G ProSe remote UE, if the 5G ProSe remote UE's authorization information is not locally available, the 5G PKMF can request the authorization information from the UDM of the 5G ProSe remote UE.

In an example control plane solution, the relay access and mobility management function (AMF) should authorize the relay UE. For a remote UE, an authorization server function (AUSF) receives the authorization information from UDM and store it in a ProSe anchor function (PAnF).

The Remote UE can use 5G ProSe remote user key (5GPRUK) identifier (5GPRUK ID) to ask for the UE-to-network relay service. Disclosed herein are techniques for refreshing and updating the a user key such as 5GPRUK.

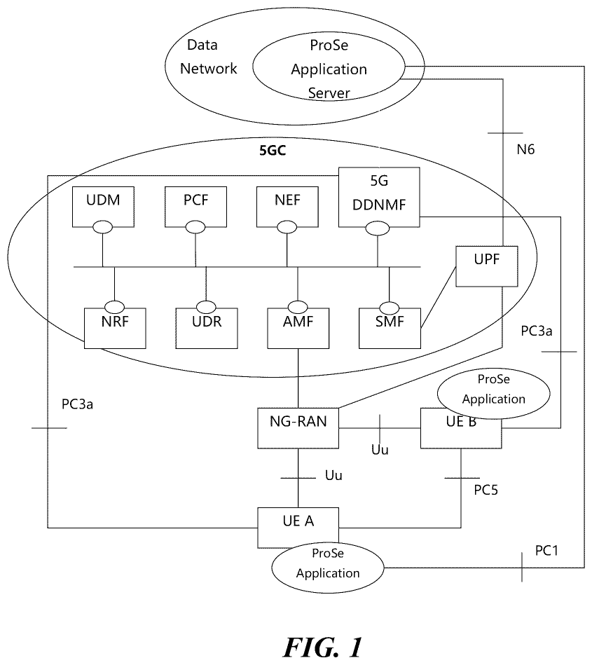

FIG. 1 shows an example architecture for some implementations consistent with the disclosed subject matter.

In the architecture of FIG. 1, a 5G direct discovery name management function (DDNMF) is introduced into the 5GC as a new network function. The 5G DDNMF has similar functions from architecture point of view to the DDNMF part of ProSe Function such as that described in TS 23.303.

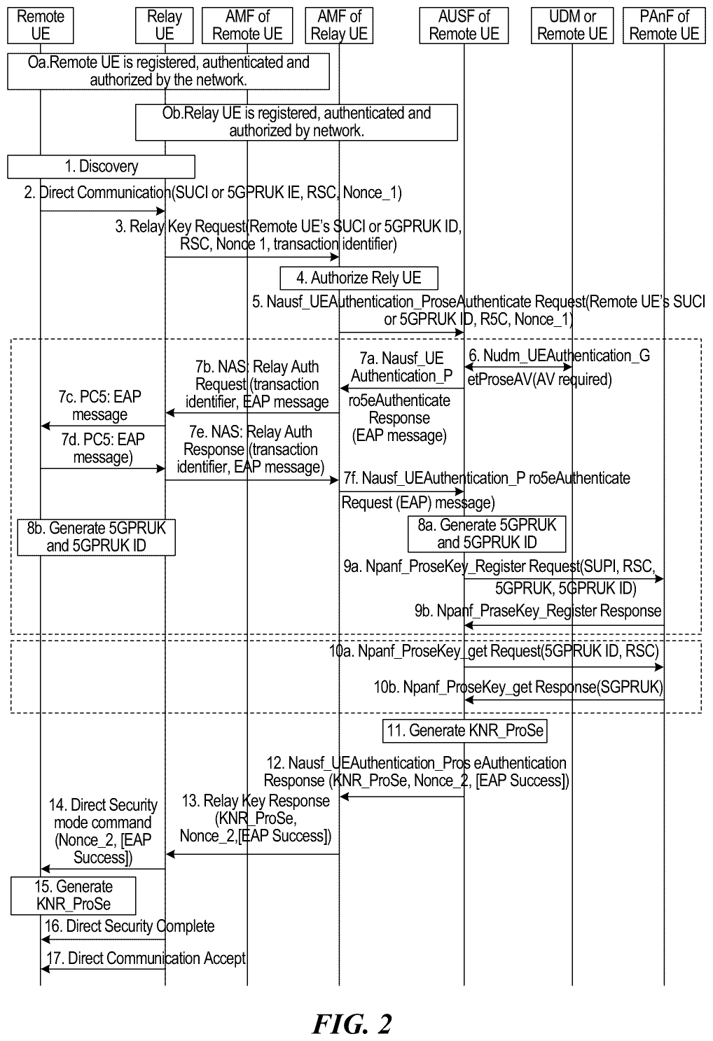

A security procedure over a control plane is described below in 0-17 and corresponding items in FIG. 2 (see e.g., TS 33.503, clause 6.3.3.3).
0. The 5G ProSe Remote UE and the 5G ProSe UE-to-Network Relay can be registered with the network. The 5G ProSe UE-to-Network Relay can be authenticated and authorized by the network to provide UE-to-Network Relay service. The 5G ProSe Remote UE can be authenticated and authorized by the network to receive UE-to-Network Relay service. PC5 security policies are provisioned to the 5G ProSe Remote UE and the 5G ProSe UE-to-Network Relay respectively during this authorization and information provisioning procedure.
1. The 5G ProSe Remote UE can initiate discovery procedure using any of Model A or Model B method as specified in clause 6.3.1.2 or 6.3.1.3 of TS 23.304 respectively.
2. After the discovery of the 5G ProSe UE-to-Network Relay, the 5G ProSe Remote UE can send a Direct Communication Request to the 5G ProSe UE-to-Network Relay for establishing secure PC5 unicast link. The 5G ProSe Remote UE can include its security capabilities and PC5 signaling security policy in the direct communication request (DCR) message as specified in TS 33.536. The message can also include Relay Service Code, Nonce_1.

If the 5G ProSe Remote UE does not have a valid 5G Prose Remote User Key (5GPRUK), the 5G ProSe Remote UE can include Subscriber Concealed Identifier (SUCI) in the DCR to trigger 5G ProSe Remote UE specific authentication and establish a 5GPRUK.

If the 5G ProSe Remote UE already has a valid 5GPRUK, the 5G ProSe Remote UE can include the 5GPRUK ID in the DCR to indicate that the 5G ProSe Remote UE wants to get relay connectivity using the 5GPRUK.
3. Upon receiving the DCR message, the 5G ProSe UE-to-Network Relay can send the Relay Key Request to the AMF of the 5G ProSe UE-to-Network Relay, including SUCI or 5GPRUK ID, RSC and Nonce_1 received in the DCR message. The 5G ProSe UE-to-Network Relay can also include in the message a transaction identifier that identifies the 5G ProSe Remote UE for the subsequent messages over 5G ProSe UE-to-Network Relay's NAS messages.
4. The AMF of the 5G ProSe UE-to-Network Relay can verify whether the 5G ProSe UE-to-Network Relay is authorized to provide the UE-to-Network Relay service.
5. The AMF of the 5G ProSe UE-to-Network Relay can select an AUSF based on SUCI or 5GPRUK ID and forward the parameters received in Relay Key Request to the AUSF in Nausf_UEAuthentication_ProseAuthenticate Request message. The Nausf_UEAuthentication_ProseAuthenticate Request message can contain the 5G ProSe Remote UE's SUCI or 5GPRUK ID, Relay Service Code, Nonce_1. If 5GPRUK ID is received from AMF of the 5G ProSe UE-to-Network Relay, the AUSF of the 5G ProSe Remote UE skips steps 6-9. If the 5G ProSe Remote UE's SUCI is received from AMF of the 5G ProSe UE-to-Network Relay, the AUSF of the 5G ProSe Remote UE skips step 10.
6. The AUSF can initiate a 5G ProSe Remote UE specific authentication using the ProSe specific parameters received (i.e., RSC, etc.). The serving network name handling is the same as defined in TS 33.501.

The AUSF of the 5G ProSe Remote UE can retrieve the Authentication Vectors and the Routing Indicator of the 5G ProSe Remote UE from the UDM via Nudm_UEAuthentication_GetProseAv Request message. Upon reception of the Nudm_UEAuthentication_GetProSeAv Request, the UDM can invoke subscriber identity de-concealing function (SIDF) to de-conceal SUCI to gain subscription permanent identifier (SUPI) before UDM can process the request. The UDM checks whether the UE is authorized to use a ProSe UE-to-Network Relay service based on authorization information in UE's Subscription data. If the UE is authorized, the UDM can choose the authentication method based on SUPI.
7a. If extensible authentication protocol authentication and key agreement (EAP-AKA′) is selected by UDM, the AUSF of the 5G ProSe Remote UE can trigger authentication of the 5G ProSe Remote UE based on EAP-AKA′. The AUSF of the 5G ProSe Remote UE generates the EAP-Request/AKA′-Challenge message defined in clause 6.1.3.1 of TS 33.501 and send EAP-Request/AKA′-Challenge message to the AMF of the 5G ProSe UE-to-Network Relay in a Nausf_UEAuthentication_ProSeAuthenticate Response message.
7b. The AMF of the 5G ProSe UE-to-Network Relay can forward the Relay Authentication Request (including the EAP-Request/AKA′-Challenge) to the 5G ProSe UE-to-Network Relay over NAS message, including transaction identifier of the 5G ProSe Remote UE in the message. The NAS message is protected using the NAS security context created for the 5G ProSe UE-to-Network Relay.
7c. Based on the transaction identifier, the 5G ProSe UE-to-Network Relay can forwards the EAP-Request/AKA′-Challenge to the 5G ProSe Remote UE over PC5 messages.

The universal subscriber identity module (USIM) in the 5G ProSe Remote UE verifies the freshness of the received values by checking whether a network authentication token (AUTN) can be accepted as described in TS 33.102.

For EAP-AKA′, the USIM computes a response RES. The USIM can return RES, CK, IK to the ME. The ME can derive CK′ and IK′ according to Annex A.3 in TS 33.501.
7d. The 5G ProSe Remote UE can return EAP-Response/AKA′-Challenge to the 5G ProSe UE-to-Network Relay over PC5 messages.
7e. The 5G ProSe UE-to-Network Relay forwards the EAP-Response/AKA′-Challenge together with the transaction identifier of the 5G ProSe Remote UE to the AMF of the 5G ProSe UE-to-Network Relay in a NAS message Relay Authentication Response.
7f. The AMF of the 5G ProSe UE-to-Network Relay forwards EAP-Response/AKA′-Challenge to the AUSF of the 5G ProSe Remote UE via Nausf_UEAuthentication_ProSeAuthenticate Request.

The AUSF of the 5G ProSe Remote UE performs the UE authentication by verifying the received information as described in TS 33.501.

For EAP-AKA′, the AUSF of the 5G ProSe Remote UE and the 5G ProSe Remote UE may exchange EAP-Request/AKA′-Notification and EAP-Response/AKA′-Notification messages via the AMF of the 5G ProSe UE-to-Network Relay and the 5G ProSe UE-to-Network Relay. After the exchanges, the AUSF of the 5G ProSe Remote UE and the 5G ProSe Remote UE can derive the K_{AUSF_P} in the same way as K_{AUSF} is derived in TS33.501.
8. On successful authentication, the AUSF of the 5G ProSe Remote UE and the 5G ProSe Remote UE can generate 5GPRUK as specified in Annex A.2 and 5GPRUK ID.

The 5GPRUK ID is in network access identifier (NAI) format as specified in clause 2.2 of Internet Engineering Task Force (IETF) RFC 7542, i.e., username@realm. The username part includes the Routing Indicator from step 6 and the 5GPRUK ID*, and the realm part includes Home Network Identifier. The 5GPRUK ID* is specified in Annex A.3.
9a. The AUSF of the 5G ProSe Remote UE can select the PAnF (Prose Anchor Function) based on 5GPRUK ID and send the SUPI, RSC, 5GPRUK and 5GPRUK ID in Npanf_ProseKey_Register Request message to the PAnF.
9b. The PAnF can store the Prose context info (i.e., SUPI, RSC, 5GPRUK, 5GPRUK ID) for the 5G ProSe Remote UE and send Npanf_ProseKey_Register Response message to the AUSF.
10a. The AUSF of the 5G ProSe Remote UE can select the PAnF based on 5GPRUK ID and send received 5GPRUK ID and RSC in Npanf_ProseKey_get Request message.
10b. The PAnF retrieves 5GPRUK based on the 5GPRUK ID and checks whether the 5G ProSe Remote UE is authorized to use the UE-to-Network Relay service based on received RSC. If the 5G ProSe Remote UE is authorized and the retrieved 5GPRUK is valid. the PAnF sends Npanf_ProseKey_get Response message with 5GPRUK to the AUSF.
11. The AUSF of the 5G ProSe Remote UE can generate Nonce_2 and derive the K_{NR_ProSe} key using 5GPRUK, Nonce_1 and Nonce_2 as defined in Annex A.4.
12. The AUSF of the 5G ProSe Remote UE can send the K_{NR_ProSe}, Nonce_2 in Nausf_UEAuthentication_ProseAuthenticate Response message to the 5G ProSe UE-to-Network Relay via the AMF of the 5G ProSe UE-to-Network Relay. EAP Success message can be included if step 7 is performed successfully. The AUSF of the 5G ProSe Remote UE can also include the 5GPRUK ID in the message if generated in step 8.
13. When receiving a K_{NR_ProSe} from the AUSF of the 5G ProSe Remote UE via the AMF of the 5G ProSe UE-to-Network Relay, the 5G ProSe UE-to-Network Relay derives PC5 session key K_{relay-sess} and confidentiality key K_{relay-enc} (if applicable) and integrity key K_{relay-int} from K_{NR_ProSe}, as defined in clause 6.3.3.3.3. K_{NR_ProSe} ID and K_{relay-sess} ID are established in the same way as K_{NRP} ID and K_{NRP-Sess} ID in TS 33.536. The EAP Success message and 5GPRUK ID are also sent from the AMF of the 5G ProSe UE-to-Network Relay to UE-to-Network Relay if received from AUSF.
14. The 5G ProSe UE-to-Network Relay can send the received Nonce_2 and 5G ProSe Remote UE's PC5 signalling security policy to the 5G ProSe Remote UE in Direct Security mode command message, which is integrity protected using K_{relay-int}. EAP Success message can be included if received from the AMF of the 5G ProSe UE-to-Network Relay.
15. The 5G ProSe Remote UE can generate the K_{NR_ProSe} key to be used for remote access via the 5G ProSe UE-to-Network Relay in the same way as defined in step 11. The 5G ProSe Remote UE can derive PC5 session key K_{relay-sess} and confidentiality and integrity keys from K_{NR_ProSe} in the same way as defined in step 13.
16. The 5G ProSe Remote UE can send the Direct Security Mode Complete message containing its PC5 user plane security policies to the 5G ProSe UE-to-Network relay, which is protected by K_{relay-int} or/and K_{relay-enc} derived from K_{relay-sess} according to the negotiated PC5 signalling policies between the 5G ProSe Remote UE and the 5G ProSe UE-to-Network Relay.
17. After the successful verification of the Direct Security Mode complete message, the 5G ProSe UE-to-Network Relay responds a Direct Communication Accept message to the 5G ProSe Remote UE to finish the PC5 connection establishment procedures and store the 5GPRUK ID in the security context associated to the PC5 link with the 5G ProSe Remote UE.

Further communication between the 5G ProSe Remote UE and the Network takes place securely via the 5G ProSe UE-to-Network Relay.

### Case 1: Set a Key Lifetime

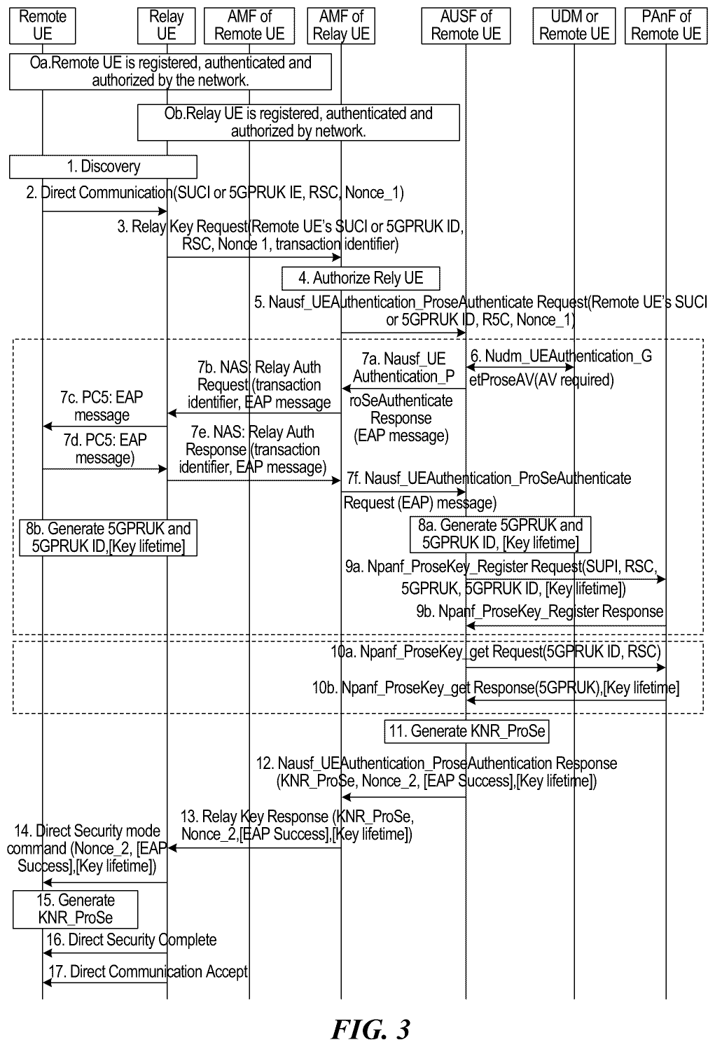

FIG. 3 and corresponding items 0-17 below show signaling and describe setting a lifetime of user key including a 5GPRUK. For case 1 below, a process for triggering a new ProSe authentication is disclosed. In some example embodiments, the network can set a lifetime for the 5GPRUK key and send the lifetime of 5GPRUK to a remote UE. In some example embodiments, the network can also set a lifetime for the 5GPRUK ID and send the lifetime of 5GPRUK ID to a remote UE. If the lifetime of 5GPRUK ID is expired, the UE should not use the 5GPRUK ID to access the service and the network will reject the service request. The key lifetime can also represent the lifetime of 5GPRUK ID.

If the lifetime of 5GPRUK is expired, the UE should not use the 5GPRUK ID to access the service and the network will reject the service request. Then the UE will use UE and a new prose authentication will happen.
0. The 5G ProSe Remote UE and the 5G ProSe UE-to-Network Relay can be registered with the network. The 5G ProSe UE-to-Network Relay can be authenticated and authorized by the network to provide UE-to-Network Relay service. The 5G ProSe Remote UE can be authenticated and authorized by the network to receive UE-to-Network Relay service. PC5 security policies are provisioned to the 5G ProSe Remote UE and the 5G ProSe UE-to-Network Relay respectively during this authorization and information provisioning procedure.
1. The 5G ProSe Remote UE can initiate discovery procedure using any of Model A or Model B method as specified in clause 6.3.1.2 or 6.3.1.3 of TS 23.304 respectively.
2. After the discovery of the 5G ProSe UE-to-Network Relay, the 5G ProSe Remote UE can send a Direct Communication Request to the 5G ProSe UE-to-Network Relay for establishing secure PC5 unicast link. The 5G ProSe Remote UE can include its security capabilities and PC5 signalling security policy in the DCR message as specified in TS 33.536. The message can also include Relay Service Code, Nonce_1.

If the 5G ProSe Remote UE does not have a valid 5G Prose Remote User Key (5GPRUK), such as the lifetime of 5GPRUK is expired, the 5G ProSe Remote UE can include SUCI in the DCR to trigger 5G ProSe Remote UE specific authentication and establish a 5GPRUK.

If the 5G ProSe Remote UE already has a valid 5GPRUK, the 5G ProSe Remote UE can include the 5GPRUK ID in the DCR to indicate that the 5G ProSe Remote UE wants to get relay connectivity using the 5GPRUK.
3. Upon receiving the DCR message, the 5G ProSe UE-to-Network Relay can send the Relay Key Request to the AMF of the 5G ProSe UE-to-Network Relay, including SUCI or 5GPRUK ID, RSC and Nonce_1 received in the DCR message. The 5G ProSe UE-to-Network Relay can also include in the message a transaction identifier that identifies the 5G ProSe Remote UE for the subsequent messages over 5G ProSe UE-to-Network Relay's NAS messages.
4. The AMF of the 5G ProSe UE-to-Network Relay can verify whether the 5G ProSe UE-to-Network Relay is authorized to provide the UE-to-Network Relay service.
5. The AMF of the 5G ProSe UE-to-Network Relay can select an AUSF based on SUCI or 5GPRUK ID and forward the parameters received in Relay Key Request to the AUSF in Nausf_UEAuthentication_ProseAuthenticate Request message. The Nausf_UEAuthentication_ProseAuthenticate Request message can contain the 5G ProSe Remote UE's SUCI or 5GPRUK ID, Relay Service Code, Nonce_1. If 5GPRUK ID is received from AMF of the 5G ProSe UE-to-Network Relay, the AUSF of the 5G ProSe Remote UE skips steps 6-9. If the 5G ProSe Remote UE's SUCI is received from AMF of the 5G ProSe UE-to-Network Relay, the AUSF of the 5G ProSe Remote UE skips step 10.
6. The AUSF can initiate a 5G ProSe Remote UE specific authentication using the ProSe specific parameters received (i.e., RSC, etc.). The serving network name handling is the same as defined in TS 33.501.

The AUSF of the 5G ProSe Remote UE can retrieve the Authentication Vectors and the Routing Indicator of the 5G ProSe Remote UE from the UDM via Nudm_UEAuthentication_GetProseAv Request message. Upon reception of the Nudm_UEAuthentication_GetProSeAv Request, the UDM can invoke SIDF de-conceal SUCI to gain SUPI before UDM can process the request. The UDM checks whether the UE is authorized to use a ProSe UE-to-Network Relay service based on authorization information in UE's Subscription data. If the UE is authorized, the UDM can choose the authentication method based on SUPI.
7a. If EAP-AKA′ is selected by UDM, the AUSF of the 5G ProSe Remote UE can trigger authentication of the 5G ProSe Remote UE based on EAP-AKA′. The AUSF of the 5G ProSe Remote UE generates the EAP-Request/AKA′-Challenge message defined in clause 6.1.3.1 of TS 33.501 and send EAP-Request/AKA′-Challenge message to the AMF of the 5G ProSe UE-to-Network Relay in a Nausf_UEAuthentication_ProSeAuthenticate Response message.
7b. The AMF of the 5G ProSe UE-to-Network Relay can forward the Relay Authentication Request (including the EAP-Request/AKA′-Challenge) to the 5G ProSe UE-to-Network Relay over NAS message, including transaction identifier of the 5G ProSe Remote UE in the message. The NAS message is protected using the NAS security context created for the 5G ProSe UE-to-Network Relay.
7c. Based on the transaction identifier, the 5G ProSe UE-to-Network Relay can forwards the EAP-Request/AKA′-Challenge to the 5G ProSe Remote UE over PC5 messages.

The USIM in the 5G ProSe Remote UE verifies the freshness of the received values by checking whether AUTN can be accepted as described in TS 33.102.

For EAP-AKA′, the USIM computes a response RES. The USIM can return RES, CK, IK to the ME. The ME can derive CK′ and IK′ according to Annex A.3 in TS 33.501.
7d. The 5G ProSe Remote UE can return EAP-Response/AKA′-Challenge to the 5G ProSe UE-to-Network Relay over PC5 messages.
7e. The 5G ProSe UE-to-Network Relay forwards the EAP-Response/AKA′-Challenge together with the transaction identifier of the 5G ProSe Remote UE to the AMF of the 5G ProSe UE-to-Network Relay in a NAS message Relay Authentication Response.
7f. The AMF of the 5G ProSe UE-to-Network Relay forwards EAP-Response/AKA′-Challenge to the AUSF of the 5G ProSe Remote UE via Nausf_UEAuthentication_ProSeAuthenticate Request.

The AUSF of the 5G ProSe Remote UE performs the UE authentication by verifying the received information as described in TS 33.501.

For EAP-AKA′, the AUSF of the 5G ProSe Remote UE and the 5G ProSe Remote UE may exchange EAP-Request/AKA′-Notification and EAP-Response/AKA′-Notification messages via the AMF of the 5G ProSe UE-to-Network Relay and the 5G ProSe UE-to-Network Relay. After the exchanges, the AUSF of the 5G ProSe Remote UE and the 5G ProSe Remote UE can derive the K_{AUSF_P} in the same way as K_{AUSF} is derived in TS33.501.
8. On successful authentication, the AUSF of the 5G ProSe Remote UE and the 5G ProSe Remote UE can generate 5GPRUK as specified in Annex A.2 and 5GPRUK ID.

The 5GPRUK ID is in NAI format as specified in clause 2.2 of IETF RFC 7542, i.e., username@realm. The username part includes the Routing Indicator from step 6 and the 5GPRUK ID*, and the realm part includes Home Network Identifier. The 5GPRUK ID* is specified in Annex A.3.

The AUSF of the 5G ProSe Remote UE and the 5G ProSe Remote UE may also generate the lifetime the 5GPRUK.
9a. The AUSF of the 5G ProSe Remote UE can select the PAnF (Prose Anchor Function) based on 5GPRUK ID and send the SUPI, RSC, 5GPRUK, the lifetime the 5GPRUK and 5GPRUK ID in Npanf_ProseKey_Register Request message to the PAnF.
9b. The PAnF can store the Prose context info (i.e., SUPI, RSC, 5GPRUK, 5GPRUK ID) for the 5G ProSe Remote UE and send Npanf_ProseKey_Register Response message to the AUSF.
10a. The AUSF of the 5G ProSe Remote UE can select the PAnF based on 5GPRUK ID and send received 5GPRUK ID and RSC in Npanf_ProseKey_get Request message.
10b. The PAnF retrieves 5GPRUK based on the 5GPRUK ID and checks whether the 5G ProSe Remote UE is authorized to use the UE-to-Network Relay service based on received RSC. If the 5G ProSe Remote UE is authorized and the retrieved 5GPRUK is valid, the PAnF sends Npanf_ProseKey_get Response message with 5GPRUK to the AUSF. The PAnF may also send the lifetime the 5GPRUK to the AUSF.
11. The AUSF of the 5G ProSe Remote UE can generate Nonce_2 and derive the K_{NR_ProSe} key using 5GPRUK, Nonce_1 and Nonce_2 as defined in Annex A.4. The AUSF may also generate the lifetime of K_{NR_ProSe}.
12. The AUSF of the 5G ProSe Remote UE can send the K_{NR_ProSe}, Nonce_2 in Nausf_UEAuthentication_ProseAuthenticate Response message to the 5G ProSe UE-to-Network Relay via the AMF of the 5G ProSe UE-to-Network Relay. EAP Success message can be included if step 7 is performed successfully. The AUSF of the 5G ProSe Remote UE can also include the 5GPRUK ID in the message if generated in step 8. The AUSF may also send the lifetime the 5GPRUK, the lifetime K_{NR_ProSe} of to the 5G ProSe UE-to-Network Relay.
13. When receiving a K_{NR_ProSe} from the AUSF of the 5G ProSe Remote UE via the AMF of the 5G ProSe UE-to-Network Relay, the 5G ProSe UE-to-Network Relay derives PC5 session key K_{relay-sess} and confidentiality key K_{relay-enc} (if applicable) and integrity key K_{relay-int} from K_{NR_ProSe}, as defined in clause 6.3.3.3.3 of this document. K_{NR_ProSe} ID and K_{relay-sess} ID are established in the same way as K_{NRP} ID and K_{NRP-sess} ID in TS 33.536 [6]. The EAP Success message and 5GPRUK ID are also sent from the AMF of the 5G ProSe UE-to-Network Relay to UE-to-Network Relay if received from AUSF.
14. The 5G ProSe UE-to-Network Relay can send the received Nonce_2 and 5G ProSe Remote UE's PC5 signalling security policy to the 5G ProSe Remote UE in Direct Security mode command message, which is integrity protected using K_{relay-int}. EAP Success message can be included if received from the AMF of the 5G ProSe UE-to-Network Relay. The ProSe UE-to-Network Relay may also send the lifetime the 5GPRUK, the lifetime K_{NR_ProSe} Of to the 5G ProSe Remote UE.
15. The 5G ProSe Remote UE can generate the K_{NR_ProSe} key to be used for remote access via the 5G ProSe UE-to-Network Relay in the same way as defined in step 11. The 5G ProSe Remote UE can derive PC5 session key K_{relay-sess} and confidentiality and integrity keys from K_{NR_ProSe} in the same way as defined in step 13. The Remote UE should store the lifetime the 5GPRUK, the lifetime K_{NR_ProSe} if received.
16. The 5G ProSe Remote UE can send the Direct Security Mode Complete message containing its PC5 user plane security policies to the 5G ProSe UE-to-Network relay, which is protected by K_{relay-int} or/and K_{relay-enc} derived from K_{relay-sess} according to the negotiated PC5 signalling policies between the 5G ProSe Remote UE and the 5G ProSe UE-to-Network Relay.
17. After the successful verification of the Direct Security Mode complete message, the 5G ProSe UE-to-Network Relay responds a Direct Communication Accept message to the 5G ProSe Remote UE to finish the PC5 connection establishment procedures and store the 5GPRUK ID in the security context associated to the PC5 link with the 5G ProSe Remote UE.

Further communication between the 5G ProSe Remote UE and the Network takes place securely via the 5G ProSe UE-to-Network Relay.

Case 2: Refresh 5GPRUK Using Subscription Permanent Identifier (SUPI) to Get a New Authentication Vector (AV) from the UDM.

A process for triggering a new ProSe authentication may be as follows. The AUSF can get SUPI from PAnF and use the SUPI to get AV from the UDM to trigger a ProSe authentication between the remote UE and the network. The AUSF can request the SUPI from the PAnF. The PAnF can send the SUPI when the AUSF sends the key request to PAnF using 5GPRUK ID. After the AUSF gets the SUPI, the AUSF trigger the prose authentication between remote UE and the network.

### Case 2.1: AUSF Decides to Refresh the 5GPRUK

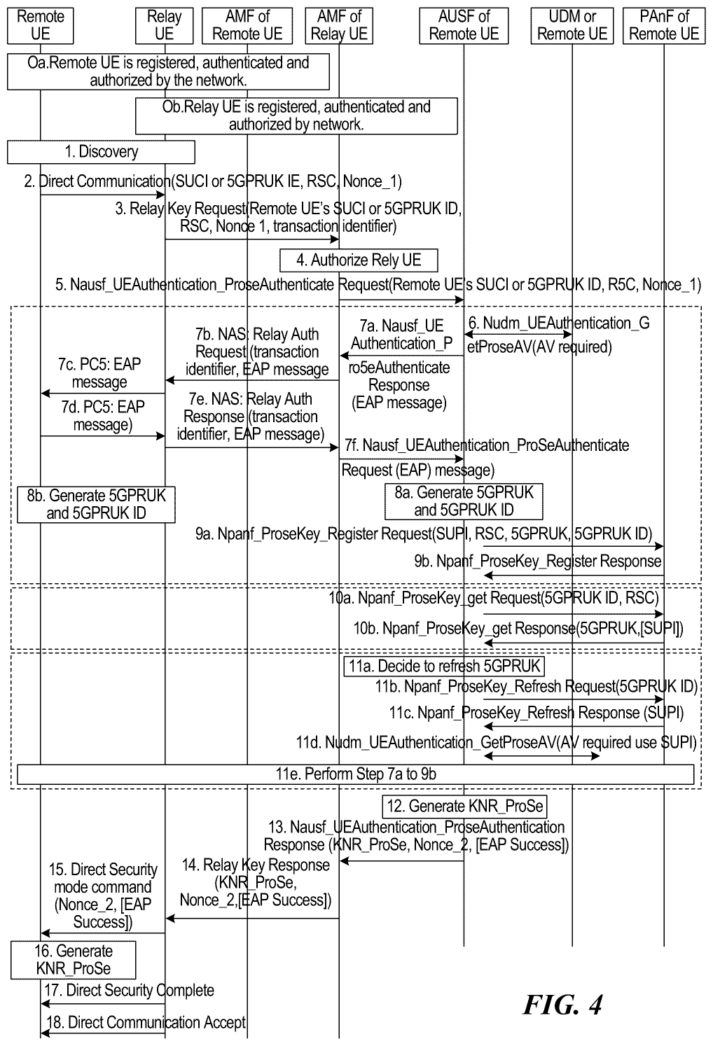

FIG. 4 and items 0-18 below show and describe an example of signaling to refresh a user key such as a 5GPRUK.
0. The 5G ProSe Remote UE and the 5G ProSe UE-to-Network Relay can be registered with the network. The 5G ProSe UE-to-Network Relay can be authenticated and authorized by the network to provide UE-to-Network Relay service. The 5G ProSe Remote UE can be authenticated and authorized by the network to receive UE-to-Network Relay service. PC5 security policies are provisioned to the 5G ProSe Remote UE and the 5G ProSe UE-to-Network Relay respectively during this authorization and information provisioning procedure.
1. The 5G ProSe Remote UE can initiate discovery procedure using any of Model A or Model B method as specified in clause 6.3.1.2 or 6.3.1.3 of TS 23.304 respectively.
2. After the discovery of the 5G ProSe UE-to-Network Relay, the 5G ProSe Remote UE can send a Direct Communication Request to the 5G ProSe UE-to-Network Relay for establishing secure PC5 unicast link. The 5G ProSe Remote UE can include its security capabilities and PC5 signalling security policy in the DCR message as specified in TS 33.536. The message can also include Relay Service Code, Nonce_1.

If the 5G ProSe Remote UE does not have a valid 5G Prose Remote User Key (5GPRUK), the 5G ProSe Remote UE can include SUCI in the DCR to trigger 5G ProSe Remote UE specific authentication and establish a 5GPRUK.

If the 5G ProSe Remote UE already has a valid 5GPRUK, the 5G ProSe Remote UE can include the 5GPRUK ID in the DCR to indicate that the 5G ProSe Remote UE wants to get relay connectivity using the 5GPRUK.
3. Upon receiving the DCR message, the 5G ProSe UE-to-Network Relay can send the Relay Key Request to the AMF of the 5G ProSe UE-to-Network Relay, including SUCI or 5GPRUK ID, RSC and Nonce_1 received in the DCR message. The 5G ProSe UE-to-Network Relay can also include in the message a transaction identifier that identifies the 5G ProSe Remote UE for the subsequent messages over 5G ProSe UE-to-Network Relay's NAS messages.
4. The AMF of the 5G ProSe UE-to-Network Relay can verify whether the 5G ProSe UE-to-Network Relay is authorized to provide the UE-to-Network Relay service.
5. The AMF of the 5G ProSe UE-to-Network Relay can select an AUSF based on SUCI or 5GPRUK ID and forward the parameters received in Relay Key Request to the AUSF in Nausf_UEAuthentication_ProseAuthenticate Request message. The Nausf_UEAuthentication_ProseAuthenticate Request message can contain the 5G ProSe Remote UE's SUCI or 5GPRUK ID, Relay Service Code, Nonce_1 and Serving network name. If 5GPRUK ID is received from AMF of the 5G ProSe UE-to-Network Relay, the AUSF of the 5G ProSe Remote UE skips steps 6-9. If the 5G ProSe Remote UE's SUCI is received from AMF of the 5G ProSe UE-to-Network Relay, the AUSF of the 5G ProSe Remote UE skips step 10.
6. The AUSF can initiate a 5G ProSe Remote UE specific authentication using the ProSe specific parameters received (i.e., RSC, etc.). The serving network name handling is the same as defined in TS 33.501.

The AUSF of the 5G ProSe Remote UE can retrieve the Authentication Vectors and the Routing Indicator of the 5G ProSe Remote UE from the UDM via Nudm_UEAuthentication_GetProseAv Request message. Upon reception of the Nudm_UEAuthentication_GetProSeAv Request, the UDM can invoke SIDF de-conceal SUCI to gain SUPI before UDM can process the request. The UDM checks whether the UE is authorized to use a ProSe UE-to-Network Relay service based on authorization information in UE's Subscription data. If the UE is authorized, the UDM can choose the authentication method based on SUPI.
7a. If EAP-AKA′ is selected by UDM, the AUSF of the 5G ProSe Remote UE can trigger authentication of the 5G ProSe Remote UE based on EAP-AKA′. The AUSF of the 5G ProSe Remote UE generates the EAP-Request/AKA′-Challenge message defined in clause 6.1.3.1 of TS 33.501 and send EAP-Request/AKA′-Challenge message to the AMF of the 5G ProSe UE-to-Network Relay in a Nausf_UEAuthentication_ProSeAuthenticate Response message.
7b. The AMF of the 5G ProSe UE-to-Network Relay can forward the Relay Authentication Request (including the EAP-Request/AKA′-Challenge) to the 5G ProSe UE-to-Network Relay over NAS message, including transaction identifier of the 5G ProSe Remote UE in the message. The NAS message is protected using the NAS security context created for the 5G ProSe UE-to-Network Relay.
7c. Based on the transaction identifier, the 5G ProSe UE-to-Network Relay can forwards the EAP-Request/AKA′-Challenge to the 5G ProSe Remote UE over PC5 messages.

The USIM in the 5G ProSe Remote UE verifies the freshness of the received values by checking whether AUTN can be accepted as described in TS 33.102.

For EAP-AKA′, the USIM computes a response RES. The USIM can return RES, CK, IK to the ME. The ME can derive CK′ and IK′ according to Annex A.3 in TS 33.501.
7d. The 5G ProSe Remote UE can return EAP-Response/AKA′-Challenge to the 5G ProSe UE-to-Network Relay over PC5 messages.
7e. The 5G ProSe UE-to-Network Relay forwards the EAP-Response/AKA′-Challenge together with the transaction identifier of the 5G ProSe Remote UE to the AMF of the 5G ProSe UE-to-Network Relay in a NAS message Relay Authentication Response.
7f. The AMF of the 5G ProSe UE-to-Network Relay forwards EAP-Response/AKA′-Challenge to the AUSF of the 5G ProSe Remote UE via Nausf_UEAuthentication_ProSeAuthenticate Request.

The AUSF of the 5G ProSe Remote UE performs the UE authentication by verifying the received information as described in TS 33.501.

For EAP-AKA′, the AUSF of the 5G ProSe Remote UE and the 5G ProSe Remote UE may exchange EAP-Request/AKA′-Notification and EAP-Response/AKA′-Notification messages via the AMF of the 5G ProSe UE-to-Network Relay and the 5G ProSe UE-to-Network Relay. After the exchanges, the AUSF of the 5G ProSe Remote UE and the 5G ProSe Remote UE can derive the K_{AUSF_P} in the same way as K_{AUSF} is derived in TS33.501.
8. On successful authentication, the AUSF of the 5G ProSe Remote UE and the 5G ProSe Remote UE can generate 5GPRUK as specified in Annex A.2 and 5GPRUK ID.

The 5GPRUK ID is in NAI format as specified in clause 2.2 of IETF RFC 7542, i.e., username@realm. The username part includes the Routing Indicator from step 6 and the 5GPRUK ID*, and the realm part includes Home Network Identifier. The 5GPRUK ID* is specified in Annex A.3.
9a. The AUSF of the 5G ProSe Remote UE can select the PAnF (Prose Anchor Function) based on 5GPRUK ID and send the SUPI, RSC, 5GPRUK and 5GPRUK ID in Npanf_ProseKey_Register Request message to the PAnF.
9b. The PAnF can store the Prose context info (i.e., SUPI, RSC, 5GPRUK, 5GPRUK ID) for the 5G ProSe Remote UE and send Npanf_ProseKey_Register Response message to the AUSF.
10a. The AUSF of the 5G ProSe Remote UE can select the PAnF based on 5GPRUK ID and send received 5GPRUK ID and RSC in Npanf_ProseKey_get Request message.
10b. The PAnF retrieves 5GPRUK based on the 5GPRUK ID and checks whether the 5G ProSe Remote UE is authorized to use the UE-to-Network Relay service based on received RSC. If the 5G ProSe Remote UE is authorized and the retrieved 5GPRUK is valid, the PAnF sends Npanf_ProseKey_get Response message with 5GPRUK to the AUSF.

The PAnF may also include the SUPI in the Npanf_ProseKey_get Response message. The message may also include an indication to the AUSF to refresh the 5GPRUK.
11a. The AUSF decides to refresh 5GPRUK based on its local policy, such as the lifetime of the 5GPRUK. The decision may happen after step 5 or after step 10b. If the AUSF has already received the SUPI in step 10b, then step 11b˜11c are skipped.
11b. The AUSF sends a Npanf_ProseKey_Refresh Request to the PAnF. The message should include the 5GPRUK ID. The message has an explicit indication (such as a parameter in the message) or implicit indication (such as the message name itself) to the PAnF that the 5GPRUK need to be refreshed.
11c. The PAnF retrieval the Prose context based on the 5GPRUK ID, and sends the SUPI in the Npanf_ProseKey_Refresh Response to the AUSF.
11d. The AUSF use the SUPI to get the AV from the UDM. The AUSF can initiate a 5G ProSe Remote UE specific authentication using the ProSe specific parameters received (i.e., RSC, etc.). The serving network name handling is the same as defined in TS 33.501.

The AUSF of the 5G ProSe Remote UE can retrieve the Authentication Vectors and the Routing Indicator of the 5G ProSe Remote UE from the UDM via Nudm_UEAuthentication_GetProseAv Request message.
11e. The AUSF and Remote UE perform authentication use the Step 7a to step 9b.
12. The AUSF of the 5G ProSe Remote UE can generate Nonce_2 and derive the K_{NR_ProSe} key using 5GPRUK, Nonce_1 and Nonce_2 as defined in Annex A.4.
13. The AUSF of the 5G ProSe Remote UE can send the K_{NR_ProSe}, Nonce_2 in Nausf_UEAuthentication_ProseAuthenticate Response message to the 5G ProSe UE-to-Network Relay via the AMF of the 5G ProSe UE-to-Network Relay. EAP Success message can be included if step 7 is performed successfully. The AUSF of the 5G ProSe Remote UE can also include the 5GPRUK ID in the message if generated in step 8.
14. When receiving a K_{NR_ProSe} from the AUSF of the 5G ProSe Remote UE via the AMF of the 5G ProSe UE-to-Network Relay, the 5G ProSe UE-to-Network Relay derives PC5 session key K_{relay-sess} and confidentiality key K_{relay-enc} (if applicable) and integrity key K_{relay-int} from K_{NR_ProSe}, as defined in clause 6.3.3.3.3 of this document. K_{NR_ProSe} ID and K_{relay-sess} ID are established in the same way as K_{NRP} ID and K_{NRP-sess} ID in TS 33.536. The EAP Success message and 5GPRUK ID are also sent from the AMF of the 5G ProSe UE-to-Network Relay to UE-to-Network Relay if received from AUSF.
15. The 5G ProSe UE-to-Network Relay can send the received Nonce_2 and 5G ProSe Remote UE's PC5 signalling security policy to the 5G ProSe Remote UE in Direct Security mode command message, which is integrity protected using K_{relay-int}. EAP Success message can be included if received from the AMF of the 5G ProSe UE-to-Network Relay.
16. The 5G ProSe Remote UE can generate the K_{NR_ProSe} key to be used for remote access via the 5G ProSe UE-to-Network Relay. The 5G ProSe Remote UE can derive PC5 session key K_{relay-sess} and confidentiality and integrity keys from K_{NR_ProSe}.
17. The 5G ProSe Remote UE can send the Direct Security Mode Complete message containing its PC5 user plane security policies to the 5G ProSe UE-to-Network relay, which is protected by K_{relay-int} or/and K_{relay-enc} derived from K_{relay-sess} according to the negotiated PC5 signalling policies between the 5G ProSe Remote UE and the 5G ProSe UE-to-Network Relay.
18. After the successful verification of the Direct Security Mode complete message, the 5G ProSe UE-to-Network Relay responds a Direct Communication Accept message to the 5G ProSe Remote UE to finish the PC5 connection establishment procedures and store the 5GPRUK ID in the security context associated to the PC5 link with the 5G ProSe Remote UE.

Further communication between the 5G ProSe Remote UE and the Network takes place securely via the 5G ProSe UE-to-Network Relay.

### Case 2.2: PAnF Decides to Refresh the 5GPRUK

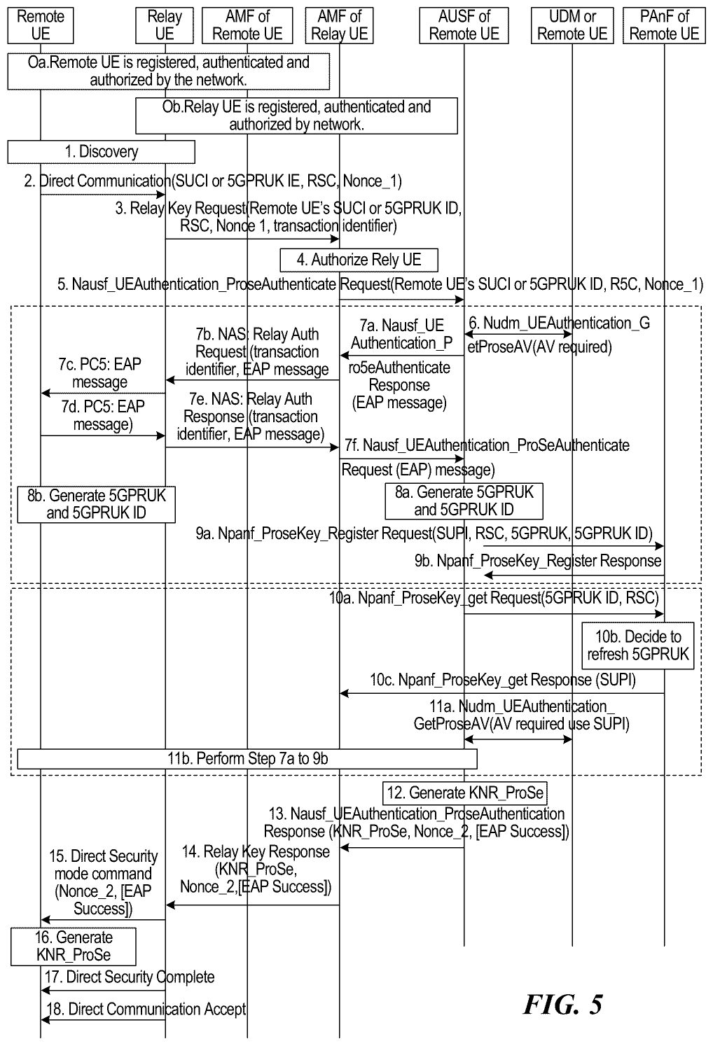

FIG. 5 and items 0-18 describe refreshing the 5GPRUK based on a determination to do so by the PAnF. Items 0-9b are the same as the items 0-9b in case 2.1.
10a. The AUSF of the 5G ProSe Remote UE can select the PAnF based on 5GPRUK ID and send received 5GPRUK ID and RSC in Npanf_ProseKey_get Request message.
10b. The PAnF decides whether to refresh the 5GPRUK based on its local policy, such as the lifetime of 5GPRUK.
10c. The PAnF retrieves 5GPRUK based on the 5GPRUK ID and checks whether the 5G ProSe Remote UE is authorized to use the UE-to-Network Relay service based on received RSC. If the 5G ProSe Remote UE is authorized and the retrieved 5GPRUK is valid, the PAnF sends Npanf_ProseKey_get Response message with 5GPRUK to the AUSF. Then skip step 11.

If the PAnF decide to refresh the 5GPRUK, then the PAnF sends Npanf_ProseKey_get Response message with SUPI to the AUSF.
11a. The AUSF use the SUPI to get the AV from the UDM. The AUSF can initiate a 5G ProSe Remote UE specific authentication using the ProSe specific parameters received (i.e., RSC, etc.). The serving network name handling is the same as defined in TS 33.501.

The AUSF of the 5G ProSe Remote UE can retrieve the Authentication Vectors and the Routing Indicator of the 5G ProSe Remote UE from the UDM via Nudm_UEAuthentication_GetProseAv Request message.
11b. The AUSF and Remote UE perform authentication use the Step 7a to step 9b.
12. The AUSF of the 5G ProSe Remote UE can generate Nonce_2 and derive the K_{NR_ProSe} key using 5GPRUK, Nonce_1 and Nonce_2 as defined in Annex A.4.
13. The AUSF of the 5G ProSe Remote UE can send the K_{NR_ProSe}, Nonce_2 in Nausf_UEAuthentication_ProseAuthenticate Response message to the 5G ProSe UE-to-Network Relay via the AMF of the 5G ProSe UE-to-Network Relay. EAP Success message can be included if step 7 is performed successfully. The AUSF of the 5G ProSe Remote UE can also include the 5GPRUK ID in the message if generated in step 8.
14. When receiving a K_{NR_ProSe} from the AUSF of the 5G ProSe Remote UE via the AMF of the 5G ProSe UE-to-Network Relay, the 5G ProSe UE-to-Network Relay derives PC5 session key K_{relay-sess} and confidentiality key K_{relay-enc} (if applicable) and integrity key K_{relay-int} from K_{NR_ProSe}, as defined in clause 6.3.3.3.3 of this document. K_{NR_ProSe} ID and K_{relay-sess} ID are established in the same way as K_{NRP} ID and K_{NRP-sess} ID in TS 33.536. The EAP Success message and 5GPRUK ID are also sent from the AMF of the 5G ProSe UE-to-Network Relay to UE-to-Network Relay if received from AUSF.
15. The 5G ProSe UE-to-Network Relay can send the received Nonce_2 and 5G ProSe Remote UE's PC5 signalling security policy to the 5G ProSe Remote UE in Direct Security mode command message, which is integrity protected using K_{relay-int}. EAP Success message can be included if received from the AMF of the 5G ProSe UE-to-Network Relay.
16. The 5G ProSe Remote UE can generate the K_{NR_ProSe} key to be used for remote access via the 5G ProSe UE-to-Network Relay. The 5G ProSe Remote UE can derive PC5 session key K_{relay-sess} and confidentiality and integrity keys from K_{NR_ProSe}.
17. The 5G ProSe Remote UE can send the Direct Security Mode Complete message containing its PC5 user plane security policies to the 5G ProSe UE-to-Network relay, which is protected by K_{relay-int} or/and K_{relay-enc} derived from K_{relay-sess} according to the negotiated PC5 signalling policies between the 5G ProSe Remote UE and the 5G ProSe UE-to-Network Relay.
18. After the successful verification of the Direct Security Mode complete message, the 5G ProSe UE-to-Network Relay responds a Direct Communication Accept message to the 5G ProSe Remote UE to finish the PC5 connection establishment procedures and store the 5GPRUK ID in the security context associated to the PC5 link with the 5G ProSe Remote UE.

Further communication between the 5G ProSe Remote UE and the Network takes place securely via the 5G ProSe UE-to-Network Relay.

### Case 3: Generate the Horizontal 5GPRUK.

In some embodiments, a method of generating a new key (also referred to as a horizontal key) based on the old key (e.g., 5GPRUK) may be as follows. A horizontal key is one whose value is determined from a previous value of the key. In some example embodiments, the 5GPRUK can be generated based on one or more parameters including: 5GPRUK, the horizontal indication, Nonce_1, Nonce_2, and/or a counter. The AUSF may send a horizontal fresh indication to the remote UE

### Case 3.1: AUSF Generates the Horizontal 5GPRUK′

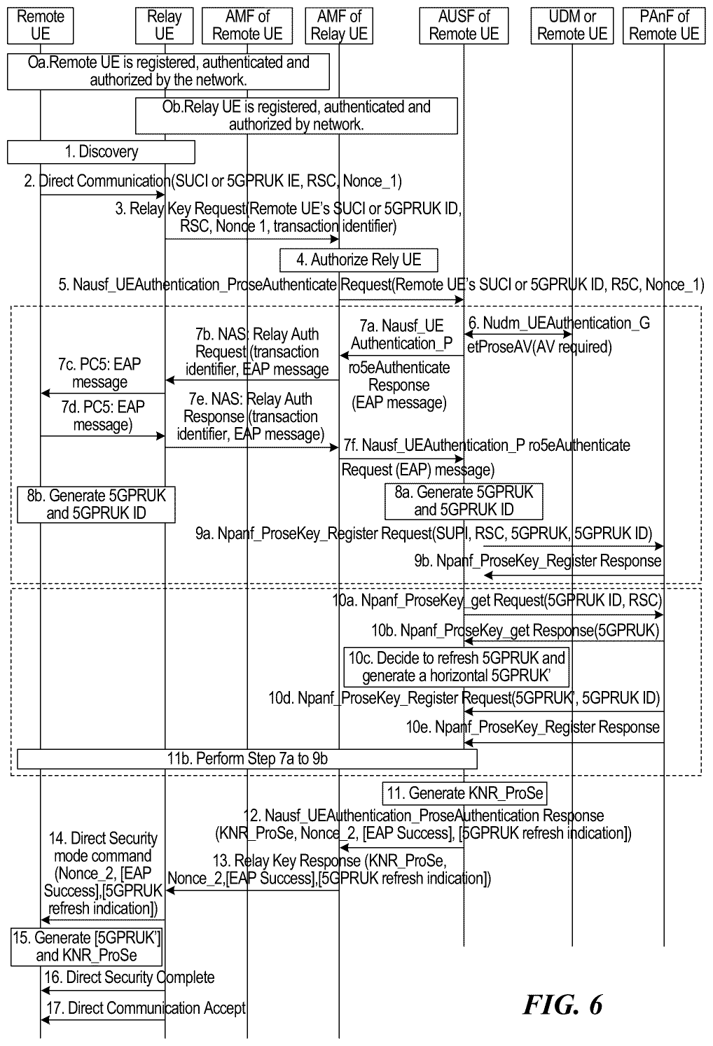

FIG. 6 and items 0-17 below show and describe signaling for generating a new 5GPRUK based on a previous 5GPRUK.
0. The 5G ProSe Remote UE and the 5G ProSe UE-to-Network Relay can be registered with the network. The 5G ProSe UE-to-Network Relay can be authenticated and authorized by the network to provide UE-to-Network Relay service. The 5G ProSe Remote UE can be authenticated and authorized by the network to receive UE-to-Network Relay service. PC5 security policies are provisioned to the 5G ProSe Remote UE and the 5G ProSe UE-to-Network Relay respectively during this authorization and information provisioning procedure.
1. The 5G ProSe Remote UE can initiate discovery procedure using any of Model A or Model B method as specified in clause 6.3.1.2 or 6.3.1.3 of TS 23.304 respectively.
2. After the discovery of the 5G ProSe UE-to-Network Relay, the 5G ProSe Remote UE can send a Direct Communication Request to the 5G ProSe UE-to-Network Relay for establishing secure PC5 unicast link. The 5G ProSe Remote UE can include its security capabilities and PC5 signalling security policy in the DCR message as specified in TS 33.536. The message can also include Relay Service Code, Nonce_1.

If the 5G ProSe Remote UE does not have a valid 5G Prose Remote User Key (5GPRUK), the 5G ProSe Remote UE can include SUCI in the DCR to trigger 5G ProSe Remote UE specific authentication and establish a 5GPRUK.

If the 5G ProSe Remote UE already has a valid 5GPRUK, the 5G ProSe Remote UE can include the 5GPRUK ID in the DCR to indicate that the 5G ProSe Remote UE wants to get relay connectivity using the 5GPRUK.
3. Upon receiving the DCR message, the 5G ProSe UE-to-Network Relay can send the Relay Key Request to the AMF of the 5G ProSe UE-to-Network Relay, including SUCI or 5GPRUK ID, RSC and Nonce_1 received in the DCR message. The 5G ProSe UE-to-Network Relay can also include in the message a transaction identifier that identifies the 5G ProSe Remote UE for the subsequent messages over 5G ProSe UE-to-Network Relay's NAS messages.
4. The AMF of the 5G ProSe UE-to-Network Relay can verify whether the 5G ProSe UE-to-Network Relay is authorized to provide the UE-to-Network Relay service.
5. The AMF of the 5G ProSe UE-to-Network Relay can select an AUSF based on SUCI or 5GPRUK ID and forward the parameters received in Relay Key Request to the AUSF in Nausf_UEAuthentication_ProseAuthenticate Request message. The Nausf_UEAuthentication_ProseAuthenticate Request message can contain the 5G ProSe Remote UE's SUCI or 5GPRUK ID, Relay Service Code, Nonce_1. If 5GPRUK ID is received from AMF of the 5G ProSe UE-to-Network Relay, the AUSF of the 5G ProSe Remote UE skips steps 6-9. If the 5G ProSe Remote UE's SUCI is received from AMF of the 5G ProSe UE-to-Network Relay, the AUSF of the 5G ProSe Remote UE skips step 10.
6. The AUSF can initiate a 5G ProSe Remote UE specific authentication using the ProSe specific parameters received (i.e., RSC, etc.). The serving network name handling is the same as defined in TS 33.501.

The AUSF of the 5G ProSe Remote UE can retrieve the Authentication Vectors and the Routing Indicator of the 5G ProSe Remote UE from the UDM via Nudm_UEAuthentication_GetProseAv Request message. Upon reception of the Nudm_UEAuthentication_GetProSeAv Request, the UDM can invoke SIDF de-conceal SUCI to gain SUPI before UDM can process the request. The UDM checks whether the UE is authorized to use a ProSe UE-to-Network Relay service based on authorization information in UE's Subscription data. If the UE is authorized, the UDM can choose the authentication method based on SUPI.
7a. If EAP-AKA′ is selected by UDM, the AUSF of the 5G ProSe Remote UE can trigger authentication of the 5G ProSe Remote UE based on EAP-AKA′. The AUSF of the 5G ProSe Remote UE generates the EAP-Request/AKA′-Challenge message defined in clause 6.1.3.1 of TS 33.501 and send EAP-Request/AKA′-Challenge message to the AMF of the 5G ProSe UE-to-Network Relay in a Nausf_UEAuthentication_ProSeAuthenticate Response message.
7b. The AMF of the 5G ProSe UE-to-Network Relay can forward the Relay Authentication Request (including the EAP-Request/AKA′-Challenge) to the 5G ProSe UE-to-Network Relay over NAS message, including transaction identifier of the 5G ProSe Remote UE in the message. The NAS message is protected using the NAS security context created for the 5G ProSe UE-to-Network Relay.
7c. Based on the transaction identifier, the 5G ProSe UE-to-Network Relay can forwards the EAP-Request/AKA′-Challenge to the 5G ProSe Remote UE over PC5 messages.

The USIM in the 5G ProSe Remote UE verifies the freshness of the received values by checking whether AUTN can be accepted as described in TS 33.102.

For EAP-AKA′, the USIM computes a response RES. The USIM can return RES, CK, IK to the ME. The ME can derive CK′ and IK′ according to Annex A.3 in TS 33.501.
7d. The 5G ProSe Remote UE can return EAP-Response/AKA′-Challenge to the 5G ProSe UE-to-Network Relay over PC5 messages.
7e. The 5G ProSe UE-to-Network Relay forwards the EAP-Response/AKA′-Challenge together with the transaction identifier of the 5G ProSe Remote UE to the AMF of the 5G ProSe UE-to-Network Relay in a NAS message Relay Authentication Response.
7f. The AMF of the 5G ProSe UE-to-Network Relay forwards EAP-Response/AKA′-Challenge to the AUSF of the 5G ProSe Remote UE via Nausf_UEAuthentication_ProSeAuthenticate Request.

The AUSF of the 5G ProSe Remote UE performs the UE authentication by verifying the received information as described in TS 33.501.

For EAP-AKA′, the AUSF of the 5G ProSe Remote UE and the 5G ProSe Remote UE may exchange EAP-Request/AKA′-Notification and EAP-Response/AKA′-Notification messages via the AMF of the 5G ProSe UE-to-Network Relay and the 5G ProSe UE-to-Network Relay. After the exchanges, the AUSF of the 5G ProSe Remote UE and the 5G ProSe Remote UE can derive the K_{AUSF_P} in the same way as K_{AUSF} is derived in TS33.501.
8. On successful authentication, the AUSF of the 5G ProSe Remote UE and the 5G ProSe Remote UE can generate 5GPRUK as specified in Annex A.2 and 5GPRUK ID.

The 5GPRUK ID is in NAI format as specified in clause 2.2 of IETF RFC 7542, i.e., username@realm. The username part includes the Routing Indicator from step 6 and the 5GPRUK ID*, and the realm part includes Home Network Identifier. The 5GPRUK ID* is specified in Annex A.3.
9a. The AUSF of the 5G ProSe Remote UE can select the PAnF (Prose Anchor Function) based on 5GPRUK ID and send the SUPI, RSC, 5GPRUK and 5GPRUK ID in Npanf_ProseKey_Register Request message to the PAnF.
9b. The PAnF can store the Prose context info (i.e., SUPI, RSC, 5GPRUK, 5GPRUK ID) for the 5G ProSe Remote UE and send Npanf_ProseKey_Register Response message to the AUSF.
10a. The AUSF of the 5G ProSe Remote UE can select the PAnF based on 5GPRUK ID and send received 5GPRUK ID and RSC in Npanf_ProseKey_get Request message.
10b. The PAnF retrieves 5GPRUK based on the 5GPRUK ID and checks whether the 5G ProSe Remote UE is authorized to use the UE-to-Network Relay service based on received RSC. If the 5G ProSe Remote UE is authorized and the retrieved 5GPRUK is valid, the PAnF sends Npanf_ProseKey_get Response message with 5GPRUK to the AUSF.

The PAnF may decide and indicate the AUSF to refresh the 5GPRUK, such as use an indication in the message. The PAnF may also provide the lifetime of 5GPRUK.
10c. If the AUSF decide to refresh the 5GPRUK based on its local policy, such as the lifetime of the 5GPRUK or the indication received from the PAnF. The AUSF generate a horizontal 5GPRUK′. The 5GPRUK′ is generated based on such parameter (at least one of them): 5GPRUK, the horizontal indication, Nonce_1, Nonce_2. The Nonce_2 used to generate the 5GPRUK′ and the K_{NR_ProSe} may be different or same.

The AUSF may also generate a Prose-MAC-I_{5GPRUK}. The parameter is generated based on the 5GPRUK, a Counter.

If the AUSF decide not to refresh the 5GPRUK, then the 10c to 10e are skipped. 10d-10e. The AUSF send the 5GPRUK′ to the PAnF. The step is generally the same with step 9a and 9b, except use 5GPRUK′ instead of 5GPRUK.
11. The AUSF of the 5G ProSe Remote UE can generate Nonce_2 and derive the K_{NR_ProSe} key using 5GPRUK, Nonce_1 and Nonce_2 as defined in Annex A.4.
12. The AUSF of the 5G ProSe Remote UE can send the K_{NR_ProSe}, Nonce_2 in Nausf_UEAuthentication_ProseAuthenticate Response message to the 5G ProSe UE-to-Network Relay via the AMF of the 5G ProSe UE-to-Network Relay. EAP Success message can be included if step 7 is performed successfully. The AUSF of the 5G ProSe Remote UE can also include the 5GPRUK ID in the message if generated in step 8. The message may also include the 5GPRUK refresh indication container which is used to indicate and generate the 5GPRUK′. The container may include the horizontal indication counter, and Prose-MAC-I_{5GPRUK}.
13. When receiving a K_{NR_ProSe} from the AUSF of the 5G ProSe Remote UE via the AMF of the 5G ProSe UE-to-Network Relay, the 5G ProSe UE-to-Network Relay derives PC5 session key K_{relay-sess} and confidentiality key K_{relay-enc} (if applicable) and integrity key K_{relay-int} from K_{NR_ProSe}, as defined in clause 6.3.3.3.3 of this document. K_{NR_ProSe} ID and K_{relay-sess} ID are established in the same way as K_{NRP} ID and K_{NRP-sess} ID in TS 33.536. The EAP Success message and 5GPRUK ID are also sent from the AMF of the 5G ProSe UE-to-Network Relay to UE-to-Network Relay if received from AUSF. The message may also include the 5GPRUK refresh indication container which is used to indicate and generate the 5GPRUK′. The container may include the horizontal indication counter, and Prose-MAC-I5GPRUK.
14. The 5G ProSe UE-to-Network Relay can send the received Nonce_2 and 5G ProSe Remote UE's PC5 signalling security policy to the 5G ProSe Remote UE in Direct Security mode command message, which is integrity protected using K_{relay-int}. EAP Success message can be included if received from the AMF of the 5G ProSe UE-to-Network Relay. The message may also include the 5GPRUK refresh indication container which is used to indicate and generate the 5GPRUK′. The container may include the horizontal indication and Prose-MAC-I_{5GPRUK}.
15. The 5G ProSe Remote UE can generate the K_{NR_ProSe} key to be used for remote access via the 5G ProSe UE-to-Network Relay in the same way as defined in step 11. The 5G ProSe Remote UE can derive PC5 session key K_{relay-sess} and confidentiality and integrity keys from K_{NR_ProSe} in the same way as defined in step 13. If 5GPRUK refresh indication container is received, the Remote UE should generate a Prose-MAC-I_{5GPRUK} and verify the received Prose-MAC-I_{5GPRUK}. If they are the same, the Remote UE generate the 5GPRUK′.
16. The 5G ProSe Remote UE can send the Direct Security Mode Complete message containing its PC5 user plane security policies to the 5G ProSe UE-to-Network relay, which is protected by K_{relay-int} or/and K_{relay-enc} derived from K_{relay-sess} according to the negotiated PC5 signalling policies between the 5G ProSe Remote UE and the 5G ProSe UE-to-Network Relay.
17. After the successful verification of the Direct Security Mode complete message, the 5G ProSe UE-to-Network Relay responds a Direct Communication Accept message to the 5G ProSe Remote UE to finish the PC5 connection establishment procedures and store the 5GPRUK ID in the security context associated to the PC5 link with the 5G ProSe Remote UE.

Further communication between the 5G ProSe Remote UE and the Network takes place securely via the 5G ProSe UE-to-Network Relay.

### Case 3.2: PAnF Generates the Horizontal 5GPRUK

### Case 3.2.1: AUSF Triggers the PAnF to Generate the Horizontal 5GPRUK

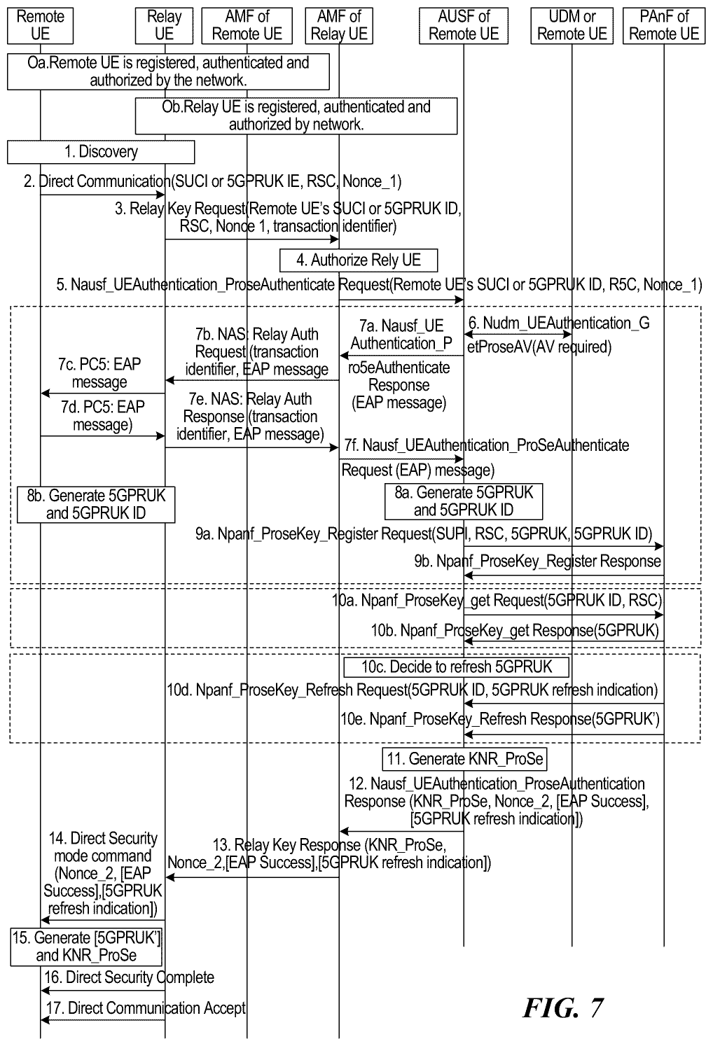

FIG. 7 and items 0-17 below show and describe signaling for generating a new 5GPRUK based on a previous 5GPRUK. Items 0-9b are the same as items 0-9b in case 3.1.
10a. The AUSF of the 5G ProSe Remote UE can select the PAnF based on 5GPRUK ID and send received 5GPRUK ID and RSC in Npanf_ProseKey_get Request message.
10b. The PAnF retrieves 5GPRUK based on the 5GPRUK ID and checks whether the 5G ProSe Remote UE is authorized to use the UE-to-Network Relay service based on received RSC. If the 5G ProSe Remote UE is authorized and the retrieved 5GPRUK is valid, the PAnF sends Npanf_ProseKey_get Response message with 5GPRUK to the AUSF.
10c. The AUSF decides to whether to refresh the 5GPRUK. This step may happen after step 5 or step 10b. If the AUSF decides not to refresh the 5GPRUK, the 10c to 10e is skipped.
10d. The AUSF sends a Npanf_ProseKey_Refresh Request message to the PAnF. The message includes the 5GPRUK ID. The message has an explicit indication (such as a parameter in the message) or implicit indication (such as the message name itself)
10e. The PAnF generate a horizontal 5GPRUK′ and sends the 5GPRUK′ in the Npanf_ProseKey_Refresh Response message to AUSF. The 5GPRUK′ is generated based on such parameter (at least one of them): 5GPRUK, the horizontal indication, Nonce_1, Nonce_2. The Nonce_2 used to generate the 5GPRUK′ and the K_{NR_ProSe} may be different or same.

The AUSF or the PAnF may also generate a Prose-MAC-I_{5GPRUK}. The parameter is generated based on the 5GPRUK, a Counter. If the Prose-MAC-I_{5GPRUK} is generated by the PAnF, the Prose-MAC-I_{5GPRUK} is sent from PAnF to AUSF in step 10e.
11. The AUSF of the 5G ProSe Remote UE can generate Nonce_2 and derive the K_{NR_ProSe} key using 5GPRUK, Nonce_1 and Nonce_2 as defined in Annex A.4.
12. The AUSF of the 5G ProSe Remote UE can send the K_{NR_ProSe}, Nonce_2 in Nausf_UEAuthentication_ProseAuthenticate Response message to the 5G ProSe UE-to-Network Relay via the AMF of the 5G ProSe UE-to-Network Relay. EAP Success message can be included if step 7 is performed successfully. The AUSF of the 5G ProSe Remote UE can also include the 5GPRUK ID in the message if generated in step 8. The message may also include the 5GPRUK refresh indication container which is used to indicate and generate the 5GPRUK′. The container may include the horizontal indication.
13. When receiving a K_{NR_ProSe} from the AUSF of the 5G ProSe Remote UE via the AMF of the 5G ProSe UE-to-Network Relay, the 5G ProSe UE-to-Network Relay derives PC5 session key K_{relay-sess} and confidentiality key K_{relay-enc} (if applicable) and integrity key K_{relay-int} from K_{NR_ProSe}, as defined in clause 6.3.3.3.3 of this document. K_{NR_ProSe} ID and K_{relay-sess} ID are established in the same way as K_{NRP} ID and K_{NRP-sess} ID in TS 33.536. The EAP Success message and 5GPRUK ID and 5GPRUK refresh indication container are also sent from the AMF of the 5G ProSe UE-to-Network Relay to UE-to-Network Relay if received from AUSF.
14. The 5G ProSe UE-to-Network Relay can send the received Nonce_2 and 5G ProSe Remote UE's PC5 signalling security policy to the 5G ProSe Remote UE in Direct Security mode command message, which is integrity protected using K_{relay-int}. EAP Success message and 5GPRUK refresh indication container can be included if received from the AMF of the 5G ProSe UE-to-Network Relay.
15. The 5G ProSe Remote UE can generate the K_{NR_ProSe} key to be used for remote access via the 5G ProSe UE-to-Network Relay in the same way as defined in step 11. The 5G ProSe Remote UE can derive PC5 session key K_{relay-sess} and confidentiality and integrity keys from K_{NR_ProSe} in the same way as defined in step 13. If 5GPRUK refresh indication container is received, the Remote UE should generate a Prose-MAC-I_{5GPRUK} and verify the received Prose-MAC-I_{5GPRUK}. If they are the same, the Remote UE generate the 5GPRUK′.
16. The 5G ProSe Remote UE can send the Direct Security Mode Complete message containing its PC5 user plane security policies to the 5G ProSe UE-to-Network relay, which is protected by K_{relay-int} or/and K_{relay-enc} derived from K_{relay-sess} according to the negotiated PC5 signalling policies between the 5G ProSe Remote UE and the 5G ProSe UE-to-Network Relay.
17. After the successful verification of the Direct Security Mode complete message, the 5G ProSe UE-to-Network Relay responds a Direct Communication Accept message to the 5G ProSe Remote UE to finish the PC5 connection establishment procedures and store the 5GPRUK ID in the security context associated to the PC5 link with the 5G ProSe Remote UE.

Further communication between the 5G ProSe Remote UE and the Network takes place securely via the 5G ProSe UE-to-Network Relay.

### Case 3.2.2: PAnF Decide to Generate the Horizontal 5GPRUK

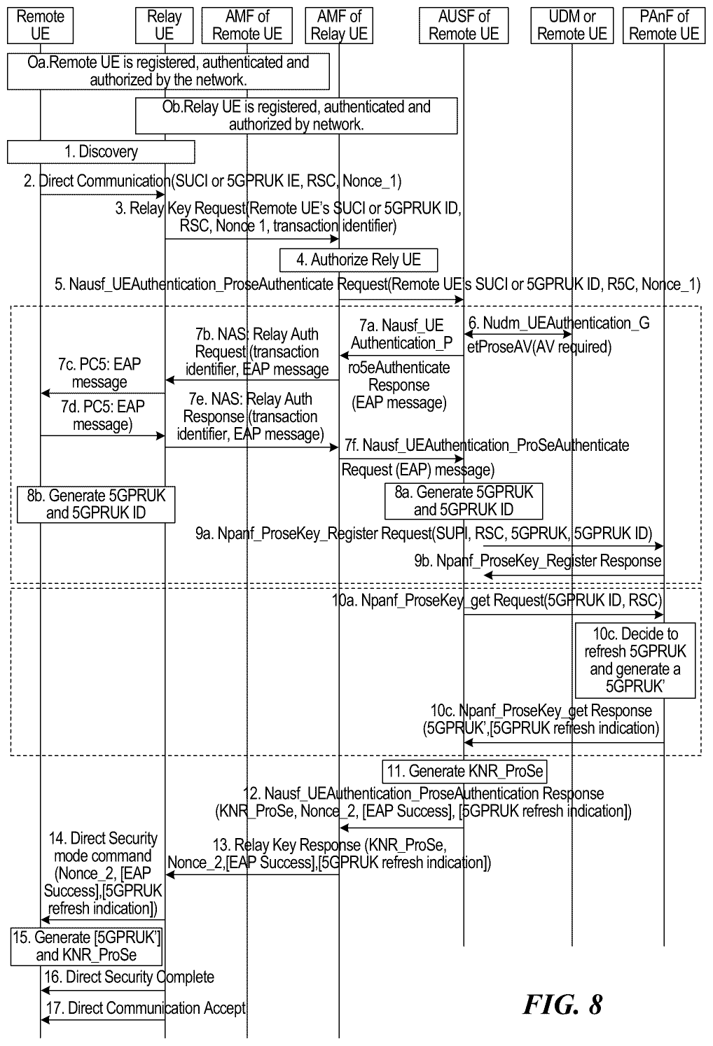

FIG. 8 and clauses 0-17 below show signaling for generating a new 5GPRUK based on a previous 5GPRUK.

The Step 0 to step 9b is the same with the step 0-9b in case 3.1.
10a. The AUSF of the 5G ProSe Remote UE can select the PAnF based on 5GPRUK ID and send received 5GPRUK ID and RSC in Npanf_ProseKey_get Request message.
10b. The PAnF decides to refresh the 5GPRUK based on its local policy, such as the lifetime of the 5GPRUK. The PAnF generate a horizontal 5GPRUK′ and sends the 5GPRUK′ in the Npanf_ProseKey_Refresh Response message to AUSF. The 5GPRUK′ is generated based on such parameter (at least one of them): 5GPRUK, the horizontal indication, Nonce_1, Nonce_2, a counter. The Nonce_2 used to generate the 5GPRUK′ and the K_{NR_ProSe} may be different or same.

The AUSF or the PAnF may also generate a Prose-MAC-I_{5GPRUK}. The parameter is generated based on the 5GPRUK, a Counter. If the Prose-MAC-I_{5GPRUK} is generated by the PAnF, the Prose-MAC-I_{5GPRUK} is sent from PAnF to AUSF in step 10c.
10c. The PAnF retrieves 5GPRUK based on the 5GPRUK ID and checks whether the 5G ProSe Remote UE is authorized to use the UE-to-Network Relay service based on received RSC. If the 5G ProSe Remote UE is authorized and the retrieved 5GPRUK is valid, the PAnF sends Npanf_ProseKey_get Response message with 5GPRUK to the AUSF.
11. The AUSF of the 5G ProSe Remote UE can generate Nonce_2 and derive the K_{NR_ProSe} key using 5GPRUK, Nonce_1 and Nonce_2 as defined in Annex A.4.
12. The AUSF of the 5G ProSe Remote UE can send the K_{NR_ProSe}, Nonce_2 in Nausf_UEAuthentication_ProseAuthenticate Response message to the 5G ProSe UE-to-Network Relay via the AMF of the 5G ProSe UE-to-Network Relay. EAP Success message can be included if step 7 is performed successfully. The AUSF of the 5G ProSe Remote UE can also include the 5GPRUK ID in the message if generated in step 8. The message may also include the 5GPRUK refresh indication container which is used to indicate and generate the 5GPRUK′. The container may include the horizontal indication.
13. When receiving a K_{NR_ProSe} from the AUSF of the 5G ProSe Remote UE via the AMF of the 5G ProSe UE-to-Network Relay, the 5G ProSe UE-to-Network Relay derives PC5 session key K_{relay-sess} and confidentiality key K_{relay-enc} (if applicable) and integrity key K_{relay-int} from K_{NR_ProSe}, as defined in clause 6.3.3.3.3 of this document. K_{NR_ProSe} ID and K_{relay-sess} ID are established in the same way as K_{NRP} ID and K_{NRP-sess} ID in TS 33.536. The EAP Success message and 5GPRUK ID and 5GPRUK refresh indication container are also sent from the AMF of the 5G ProSe UE-to-Network Relay to UE-to-Network Relay if received from AUSF.
14. The 5G ProSe UE-to-Network Relay can send the received Nonce_2 and 5G ProSe Remote UE's PC5 signalling security policy to the 5G ProSe Remote UE in Direct Security mode command message, which is integrity protected using K_{relay-int}. EAP Success message and 5GPRUK refresh indication container can be included if received from the AMF of the 5G ProSe UE-to-Network Relay.
15. The 5G ProSe Remote UE can generate the K_{NR_ProSe} key to be used for remote access via the 5G ProSe UE-to-Network Relay in the same way as defined in step 11. The 5G ProSe Remote UE can derive PC5 session key K_{relay-sess} and confidentiality and integrity keys from K_{NR_ProSe} in the same way as defined in step 13. If 5GPRUK refresh indication container is received, the Remote UE should generate a Prose-MAC-I_{5GPRUK} and verify the received Prose-MAC-I_{5GPRUK}. If they are the same, the Remote UE generate the 5GPRUK′.
16. The 5G ProSe Remote UE can send the Direct Security Mode Complete message containing its PC5 user plane security policies to the 5G ProSe UE-to-Network relay, which is protected by K_{relay-int} or/and K_{relay-enc} derived from K_{relay-sess} according to the negotiated PC5 signalling policies between the 5G ProSe Remote UE and the 5G ProSe UE-to-Network Relay.
17. After the successful verification of the Direct Security Mode complete message, the 5G ProSe UE-to-Network Relay responds a Direct Communication Accept message to the 5G ProSe Remote UE to finish the PC5 connection establishment procedures and store the 5GPRUK ID in the security context associated to the PC5 link with the 5G ProSe Remote UE.

Further communication between the 5G ProSe Remote UE and the Network takes place securely via the 5G ProSe UE-to-Network Relay.

Case 4: AUSF Stores the K_{AUSF_P}. Refresh the 5GPRUK Based on the KAUSF P.

For case 4, the K_{AUSF_P} is acquired and a new 5GPURK is derived from the K_{AUSF_P}. The AUSF and UE may store the K_{AUSF_P} and AUSF can sends its ID to the UDM. The AUSF or PAnF can request K_{AUSF_P} from UDM. The UDM can send the K_{AUSF_P} or AUSF ID to the NF. If the AUSF ID is received, the NF get the key from the AUSF. The AUSF may send a fresh indication to the remote UE

### Case 4.1: AUSF Decides to Refresh the 5GPRUK

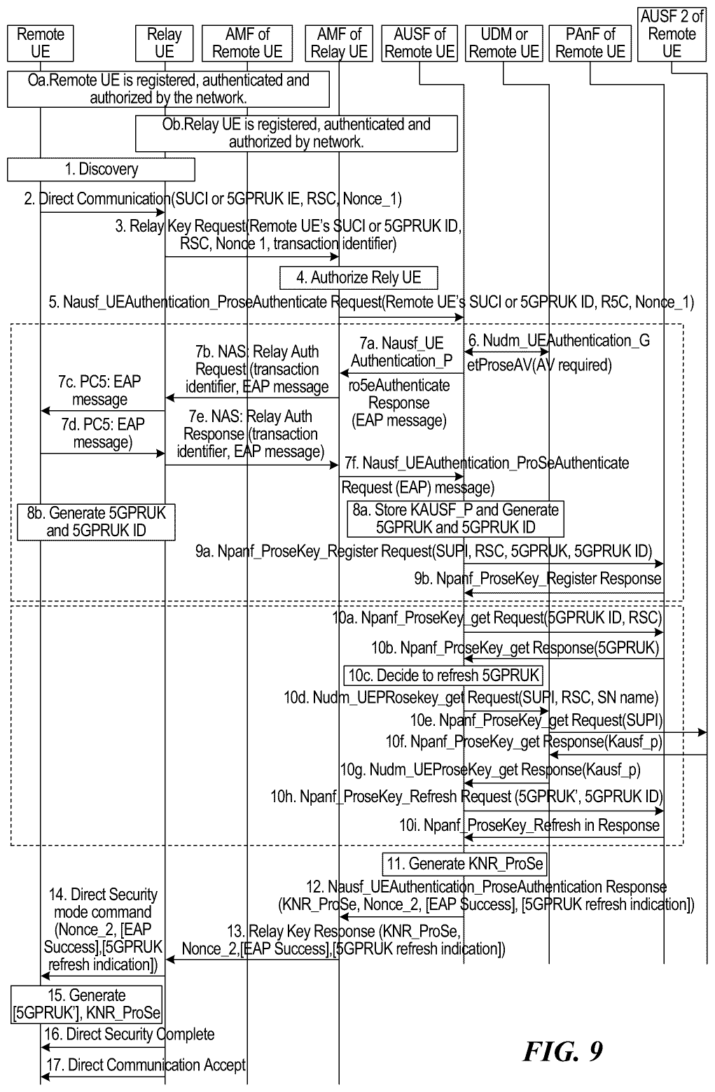

FIG. 9 and items 0-17 below show and describe signaling for refreshing a 5GPRUK based on a determination of an authentication node (e.g., AUSF).
0. The 5G ProSe Remote UE and the 5G ProSe UE-to-Network Relay can be registered with the network. The 5G ProSe UE-to-Network Relay can be authenticated and authorized by the network to provide UE-to-Network Relay service. The 5G ProSe Remote UE can be authenticated and authorized by the network to receive UE-to-Network Relay service. PC5 security policies are provisioned to the 5G ProSe Remote UE and the 5G ProSe UE-to-Network Relay respectively during this authorization and information provisioning procedure.
1. The 5G ProSe Remote UE can initiate discovery procedure using any of Model A or Model B method as specified in clause 6.3.1.2 or 6.3.1.3 of TS 23.304 respectively.
2. After the discovery of the 5G ProSe UE-to-Network Relay, the 5G ProSe Remote UE can send a Direct Communication Request to the 5G ProSe UE-to-Network Relay for establishing secure PC5 unicast link. The 5G ProSe Remote UE can include its security capabilities and PC5 signalling security policy in the DCR message as specified in TS 33.536. The message can also include Relay Service Code, Nonce_1.

If the 5G ProSe Remote UE does not have a valid 5G Prose Remote User Key (5GPRUK), the 5G ProSe Remote UE can include SUCI in the DCR to trigger 5G ProSe Remote UE specific authentication and establish a 5GPRUK.

If the 5G ProSe Remote UE already has a valid 5GPRUK, the 5G ProSe Remote UE can include the 5GPRUK ID in the DCR to indicate that the 5G ProSe Remote UE wants to get relay connectivity using the 5GPRUK.
3. Upon receiving the DCR message, the 5G ProSe UE-to-Network Relay can send the Relay Key Request to the AMF of the 5G ProSe UE-to-Network Relay, including SUCI or 5GPRUK ID, RSC and Nonce_1 received in the DCR message. The 5G ProSe UE-to-Network Relay can also include in the message a transaction identifier that identifies the 5G ProSe Remote UE for the subsequent messages over 5G ProSe UE-to-Network Relay's NAS messages.
4. The AMF of the 5G ProSe UE-to-Network Relay can verify whether the 5G ProSe UE-to-Network Relay is authorized to provide the UE-to-Network Relay service.
5. The AMF of the 5G ProSe UE-to-Network Relay can select an AUSF based on SUCI or 5GPRUK ID and forward the parameters received in Relay Key Request to the AUSF in Nausf_UEAuthentication_ProseAuthenticate Request message. The Nausf_UEAuthentication_ProseAuthenticate Request message can contain the 5G ProSe Remote UE's SUCI or 5GPRUK ID, Relay Service Code, Nonce_1. If 5GPRUK ID is received from AMF of the 5G ProSe UE-to-Network Relay, the AUSF of the 5G ProSe Remote UE skips steps 6-9. If the 5G ProSe Remote UE's SUCI is received from AMF of the 5G ProSe UE-to-Network Relay, the AUSF of the 5G ProSe Remote UE skips step 10.
6. The AUSF can initiate a 5G ProSe Remote UE specific authentication using the ProSe specific parameters received (i.e., RSC, etc.). The serving network name handling is the same as defined in TS 33.501.

The AUSF of the 5G ProSe Remote UE can retrieve the Authentication Vectors and the Routing Indicator of the 5G ProSe Remote UE from the UDM via Nudm_UEAuthentication_GetProseAv Request message. Upon reception of the Nudm_UEAuthentication_GetProSeAv Request, the UDM can invoke SIDF de-conceal SUCI to gain SUPI before UDM can process the request. The UDM checks whether the UE is authorized to use a ProSe UE-to-Network Relay service based on authorization information in UE's Subscription data. If the UE is authorized, the UDM can choose the authentication method based on SUPI.
7a. If EAP-AKA′ is selected by UDM, the AUSF of the 5G ProSe Remote UE can trigger authentication of the 5G ProSe Remote UE based on EAP-AKA′. The AUSF of the 5G ProSe Remote UE generates the EAP-Request/AKA′-Challenge message defined in clause 6.1.3.1 of TS 33.501 and send EAP-Request/AKA′-Challenge message to the AMF of the 5G ProSe UE-to-Network Relay in a Nausf_UEAuthentication_ProSeAuthenticate Response message.
7b. The AMF of the 5G ProSe UE-to-Network Relay can forward the Relay Authentication Request (including the EAP-Request/AKA′-Challenge) to the 5G ProSe UE-to-Network Relay over NAS message, including transaction identifier of the 5G ProSe Remote UE in the message. The NAS message is protected using the NAS security context created for the 5G ProSe UE-to-Network Relay.
7c. Based on the transaction identifier, the 5G ProSe UE-to-Network Relay can forwards the EAP-Request/AKA′-Challenge to the 5G ProSe Remote UE over PC5 messages.

The USIM in the 5G ProSe Remote UE verifies the freshness of the received values by checking whether AUTN can be accepted as described in TS 33.102.

For EAP-AKA′, the USIM computes a response RES. The USIM can return RES, CK, IK to the ME. The ME can derive CK′ and IK′ according to Annex A.3 in TS 33.501.
7d. The 5G ProSe Remote UE can return EAP-Response/AKA′-Challenge to the 5G ProSe UE-to-Network Relay over PC5 messages.
7e. The 5G ProSe UE-to-Network Relay forwards the EAP-Response/AKA′-Challenge together with the transaction identifier of the 5G ProSe Remote UE to the AMF of the 5G ProSe UE-to-Network Relay in a NAS message Relay Authentication Response.
7f. The AMF of the 5G ProSe UE-to-Network Relay forwards EAP-Response/AKA′-Challenge to the AUSF of the 5G ProSe Remote UE via Nausf_UEAuthentication_ProSeAuthenticate Request.

The AUSF of the 5G ProSe Remote UE performs the UE authentication by verifying the received information as described in TS 33.501.

For EAP-AKA′, the AUSF of the 5G ProSe Remote UE and the 5G ProSe Remote UE may exchange EAP-Request/AKA′-Notification and EAP-Response/AKA′-Notification messages via the AMF of the 5G ProSe UE-to-Network Relay and the 5G ProSe UE-to-Network Relay. After the exchanges, the AUSF of the 5G ProSe Remote UE and the 5G ProSe Remote UE can derive the K_{AUSF_P} in the same way as K_{AUSF} is derived in TS33.501.
8. On successful authentication, the AUSF of the 5G ProSe Remote UE and the 5G ProSe Remote UE can generate 5GPRUK and 5GPRUK ID.

The 5GPRUK ID is in NAI format as specified in clause 2.2 of IETF RFC 7542, i.e., username@realm. The username part includes the Routing Indicator from step 6 and the 5GPRUK ID*, and the realm part includes Home Network Identifier. The 5GPRUK ID* is specified in Annex A.3.

The UE and AUSF can store the K_{AUSF_P}.
9a. The AUSF of the 5G ProSe Remote UE can select the PAnF (Prose Anchor Function) based on 5GPRUK ID and send the SUPI, RSC, 5GPRUK and 5GPRUK ID in Npanf_ProseKey_Register Request message to the PAnF.
9b. The PAnF can store the Prose context info (i.e., SUPI, RSC, 5GPRUK, 5GPRUK ID) for the 5G ProSe Remote UE and send Npanf_ProseKey_Register Response message to the AUSF.
9c. The AUSF can inform UDM about the result and time of an authentication procedure with a UE using a Nudm_UEProseAuthentication_ResultConfirmation Request. This can include the SUPI, a timestamp of the authentication, the authentication type (e.g., EAP method or 5G-AKA), and the serving network name.
9d. The UDM can store the authentication status of the UE (SUPI, authentication result, timestamp, and the serving network name). UDM can store the AUSF instance ID.
9e. UDM can reply to AUSF with a Nudm_UEProseAuthentication_ResultConfirmation Response
10a. The AUSF of the 5G ProSe Remote UE can select the PAnF based on 5GPRUK ID and send received 5GPRUK ID and RSC in Npanf_ProseKey_get Request message.
10b: The PAnF retrieves 5GPRUK based on the 5GPRUK ID and checks whether the 5G ProSe Remote UE is authorized to use the UE-to-Network Relay service based on received RSC. If the 5G ProSe Remote UE is authorized and the retrieved 5GPRUK is valid, the PAnF sends Npanf_ProseKey_get Response message with 5GPRUK to the AUSF.

The PAnF may also include the SUPI in the Npanf_ProseKey_get Response message. The message may also include an indication to the AUSF to refresh the 5GPRUK.

Clause 10c. This step can happen after step 5 or step 10b. If the AUSF decides to refresh the 5GPRUK and AUSF does not received SUPI in step 10b, the AUSF can sends a message to get SUPI from the PAnF (such as the step 11b and step 11c in case 2.1).
10d. The AUSF sends a Nudm_UEProseKey_get Request to UDM. The message should include the SUPI, RSC and Serving network name.

There are two options here:

Option 1 (which is shown in the figure, UDM get the key and sends to AUSF1)
10e. The UDM use SUPI to find the stored AUSF instance ID, and sends a Nausf_Prose_get Request to AUSF 2.
10f. The AUSF 2 response the K_{AUSF_P} to UDM
10g. The UDM forward the K_{AUSF_P} in the Nudm_UEProseKey_get Response to the AUSF.

Option 2 (which is not shown in the figure, AUSF 1 directly get the key from AUSF 2)
10e. The UDM use SUPI to find the stored AUSF instance ID, and sends the AUSF instance ID in a Nudm_UEProseKey_get Response to the AUSF.
10f. The AUSF 1 sends a Nausf_Prose_get Request to AUSF 2.
10g. The AUSF 2 response the K_{AUSF_P} to AUSF 1.
10h. The AUSF 1 generate the 5GPRUK′ based on the K_{AUSF_P}. The 5GPRUK′ derivation is based on the K_{AUSF_P} and the parameter in the 5GPRUK refresh indication container. The container may include a refresh indicator, a count, a freshness parameter.

AUSF sends a Npanf_ProseKey_Refresh Request to the PAnF. The message include the new generated 5GPRUK′. If AUSF 1 does not generate a 5GPRUK′ ID, than AUSF sends the 5GPRUK ID in the message. If AUSF generate a new 5GPRUK′ ID, then the step is the same with the step 9a and step 9b, with the 5GPRUK′ and 5GPRUK′ ID instead of 5GPRUK and 5GPRUK ID.
10i. The PAnF store the 5GPRUK′. And response to the AUSF.

The AUSF may also generate a Prose-MAC-I_{AUSF_P}. The parameter is generated based on the 5GPRUK, a Counter.
11. The AUSF of the 5G ProSe Remote UE can generate Nonce_2 and derive the K_{NR_ProSe} key using 5GPRUK or 5GPRUK′, Nonce_1 and Nonce_2 as defined in Annex A.4.
12. The AUSF of the 5G ProSe Remote UE can send the K_{NR_ProSe}, Nonce_2 in Nausf_UEAuthentication_ProseAuthenticate Response message to the 5G ProSe UE-to-Network Relay via the AMF of the 5G ProSe UE-to-Network Relay. EAP Success message can be included if step 7 is performed successfully. The AUSF of the 5G ProSe Remote UE can also include the 5GPRUK ID in the message if generated in step 8. 5GPRUK refresh indication container can be included if 5GPRUK is refreshed.
13. When receiving a K_{NR_ProSe} from the AUSF of the 5G ProSe Remote UE via the AMF of the 5G ProSe UE-to-Network Relay, the 5G ProSe UE-to-Network Relay derives PC5 session key K_{relay-sess} and confidentiality key K_{relay-enc} (if applicable) and integrity key K_{relay-int} from K_{NR_ProSe}, as defined in clause 6.3.3.3.3 of this document. K_{NR_ProSe} ID and K_{relay-sess} ID are established in the same way as K_{NRP} ID and K_{NRP-sess} ID in TS 33.536. The EAP Success message and 5GPRUK ID are also sent from the AMF of the 5G ProSe UE-to-Network Relay to UE-to-Network Relay if received from AUSF. 5GPRUK refresh indication container can be included if 5GPRUK is refreshed.
14. The 5G ProSe UE-to-Network Relay can send the received Nonce_2 and 5G ProSe Remote UE's PC5 signalling security policy to the 5G ProSe Remote UE in Direct Security mode command message, which is integrity protected using K_{relay-int}. EAP Success message can be included if received from the AMF of the 5G ProSe UE-to-Network Relay. 5GPRUK refresh indication container can be included if 5GPRUK is refreshed.
15. The 5G ProSe Remote UE can generate the K_{NR_ProSe} key to be used for remote access via the 5G ProSe UE-to-Network Relay in the same way as defined in step 11. The 5G ProSe Remote UE can derive PC5 session key K_{relay-sess} and confidentiality and integrity keys from K_{NR_ProSe} in the same way as defined in step 13. If 5GPRUK refresh indication container is received, the Remote UE should generate a Prose-MAC-I_{AUSF_P} and verify the received Prose-MAC-I_{AUSF_P}. If they are the same, the Remote UE generate the 5GPRUK′.
16. The 5G ProSe Remote UE can send the Direct Security Mode Complete message containing its PC5 user plane security policies to the 5G ProSe UE-to-Network relay, which is protected by K_{relay-int} or/and K_{relay-enc} derived from K_{relay-sess} according to the negotiated PC5 signalling policies between the 5G ProSe Remote UE and the 5G ProSe UE-to-Network Relay.
17. After the successful verification of the Direct Security Mode complete message, the 5G ProSe UE-to-Network Relay responds a Direct Communication Accept message to the 5G ProSe Remote UE to finish the PC5 connection establishment procedures and store the 5GPRUK ID in the security context associated to the PC5 link with the 5G ProSe Remote UE.

Further communication between the 5G ProSe Remote UE and the Network takes place securely via the 5G ProSe UE-to-Network Relay.

### Case 4.2: PAnF Decide to Refresh the 5GPRUK

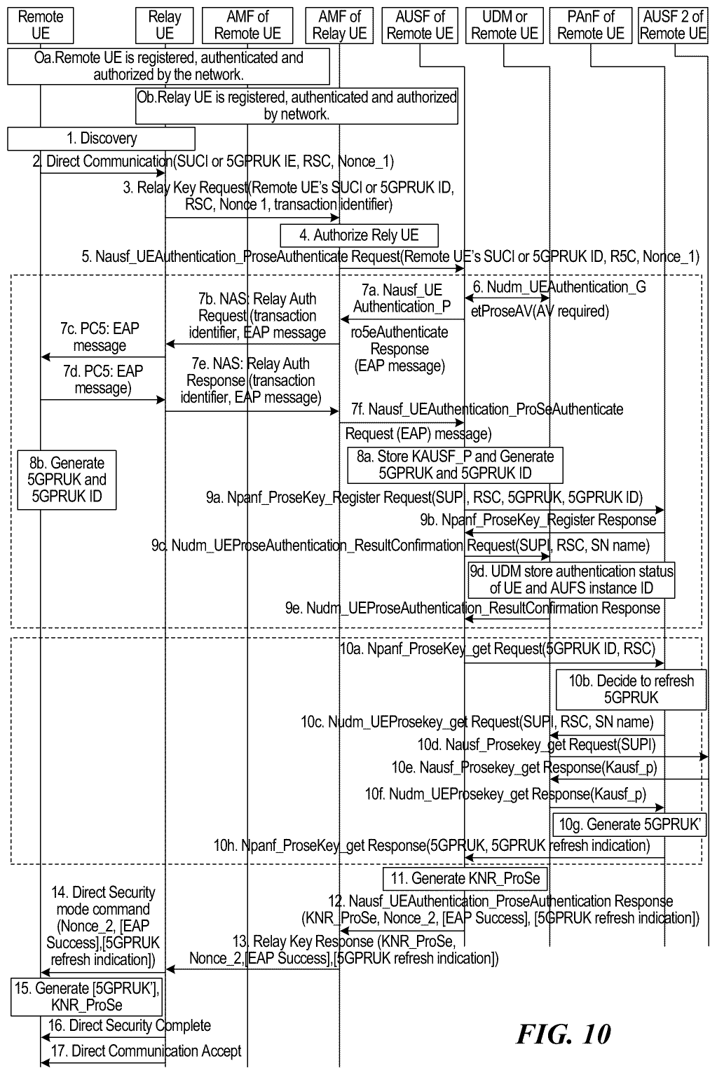

FIG. 10 and items 0-17 below show and describe signaling for refreshing a 5GPRUK based in a determination by an anchor function node (e.g., PAnF)

The Step 0 to step 9e is the same with the step 0-9e in case 4.1.
10a. The AUSF of the 5G ProSe Remote UE can select the PAnF based on 5GPRUK ID and send received 5GPRUK ID and RSC in Npanf_ProseKey_get Request message.
10b. The PAnF retrieves 5GPRUK based on the 5GPRUK ID and checks whether the 5G ProSe Remote UE is authorized to use the UE-to-Network Relay service based on received RSC. If the 5G ProSe Remote UE is authorized and the retrieved 5GPRUK is valid, the PAnF sends Npanf_ProseKey_get Response message with 5GPRUK to the AUSF and step 10c to 10g are skipped.
10c. If the PAnF decides to refresh the 5GPRUK. The PAnF sends a Nudm_UEProseKey_get Request to UDM. The message should include the SUPI, RSC.

There are two options:

Option 1 (which is shown in the figure, UDM get the key and sends to PAnF)
10d. The UDM use SUPI to find the stored AUSF instance ID, and sends a Nausf_Prose_get Request to AUSF 2.
10e. The AUSF 2 response the K_{AUSF_P} to UDM
10f. The UDM forward the K_{AUSF_P} in the Nudm_UEProseKey_get Response to the PAnF.

Option 2: (which is not shown in the figure, PAnF directly get the key from AUSF2)
10e. The UDM use SUPI to find the stored AUSF instance ID, and sends the AUSF instance ID in a Nudm_UEProseKey_get Response to the PAnF.
10e. The PAnF sends a Nausf_Prose_get Request to AUSF 2.
10f. The AUSF 2 response the K_{AUSF_P} to PAnF.
10g. The PAnF generate the 5GPRUK′ based on the K_{AUSF_P}. The 5GPRUK′ derivation is based on the K_{AUSF_P} and the parameter in the 5GPRUK refresh indication container. The container may include a refresh indicator, a count, a freshness parameter.
10h. PAnF sends a Npanf_ProseKey_get response to the AUSF. The message include the new generated 5GPRUK′ and 5GPRUK refresh indication container.

The AUSF or the PAnF may also generate a Prose-MAC-I_{AUSF_P}. The parameter is generated based on the K_{AUSF}_P, a Counter. If the Prose-MAC-I_{AUSF_P} is generated by the PAnF, the Prose-MAC-I_{5GPRUK} is sent from PAnF to AUSF in step 10h.
11. The AUSF of the 5G ProSe Remote UE can generate Nonce_2 and derive the K_{NR_ProSe} key using 5GPRUK or 5GPRUK′, Nonce_1 and Nonce_2 as defined in Annex A.4.
12. The AUSF of the 5G ProSe Remote UE can send the K_{NR_ProSe}, Nonce_2 in Nausf_UEAuthentication_ProseAuthenticate Response message to the 5G ProSe UE-to-Network Relay via the AMF of the 5G ProSe UE-to-Network Relay. EAP Success message can be included if step 7 is performed successfully. The AUSF of the 5G ProSe Remote UE can also include the 5GPRUK ID in the message if generated in step 8. 5GPRUK refresh indication container can be included if 5GPRUK is refreshed.
13. When receiving a K_{NR_ProSe} from the AUSF of the 5G ProSe Remote UE via the AMF of the 5G ProSe UE-to-Network Relay, the 5G ProSe UE-to-Network Relay derives PC5 session key K_{relay-sess} and confidentiality key K_{relay-enc} (if applicable) and integrity key K_{relay-int} from K_{NR_ProSe}, as defined in clause 6.3.3.3.3 of this document. K_{NR_ProSe} ID and K_{relay-sess} ID are established in the same way as K_{NRP} ID and K_{NRP-sess} ID in TS 33.536. The EAP Success message and 5GPRUK ID are also sent from the AMF of the 5G ProSe UE-to-Network Relay to UE-to-Network Relay if received from AUSF. 5GPRUK refresh indication container can be included if 5GPRUK is refreshed.
14. The 5G ProSe UE-to-Network Relay can send the received Nonce_2 and 5G ProSe Remote UE's PC5 signalling security policy to the 5G ProSe Remote UE in Direct Security mode command message, which is integrity protected using K_{relay-int}. EAP Success message can be included if received from the AMF of the 5G ProSe UE-to-Network Relay. 5GPRUK refresh indication container can be included if 5GPRUK is refreshed.
15. The 5G ProSe Remote UE can generate the K_{NR_ProSe} key to be used for remote access via the 5G ProSe UE-to-Network Relay in the same way as defined in step 11. The 5G ProSe Remote UE can derive PC5 session key K_{relay-sess} and confidentiality and integrity keys from K_{NR_ProSe} in the same way as defined in step 13. If 5GPRUK refresh indication container is received, the Remote UE should generate a Prose-MAC-I_{AUSF_P} and verify the received Prose-MAC-I_{AUSF_P}. If they are the same, the Remote UE generate the 5GPRUK′.
16. The 5G ProSe Remote UE can send the Direct Security Mode Complete message containing its PC5 user plane security policies to the 5G ProSe UE-to-Network relay, which is protected by K_{relay-int} or/and K_{relay-enc} derived from K_{relay-sess} according to the negotiated PC5 signalling policies between the 5G ProSe Remote UE and the 5G ProSe UE-to-Network Relay.
17. After the successful verification of the Direct Security Mode complete message, the 5G ProSe UE-to-Network Relay responds a Direct Communication Accept message to the 5G ProSe Remote UE to finish the PC5 connection establishment procedures and store the 5GPRUK ID in the security context associated to the PC5 link with the 5G ProSe Remote UE.

Further communication between the 5G ProSe Remote UE and the Network takes place securely via the 5G ProSe UE-to-Network Relay.

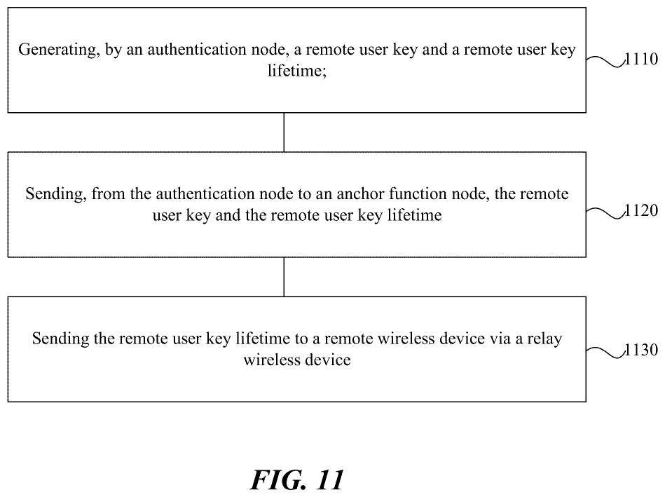

FIG. 11 depicts a process, in accordance with some example embodiments. At 1110, the process includes generating, by an authentication node, a remote user key and a remote user key lifetime. At 1120, the process includes sending, from the authentication node to an anchor function node, the remote user key and the remote user key lifetime. At 1130, the process includes sending the remote user key lifetime to a remote wireless device via a relay wireless device.

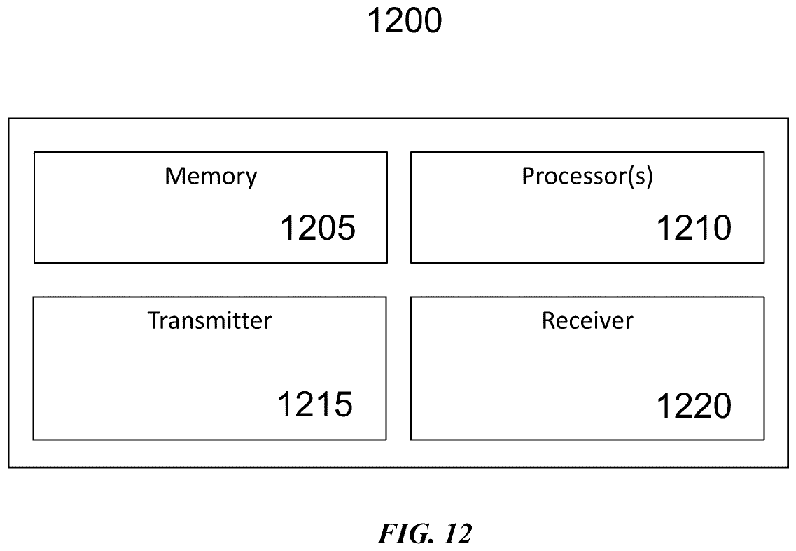

FIG. 12 shows an exemplary block diagram of a hardware platform 1200 that may be a part of a network device (e.g., base station) or a communication device (e.g., a wireless device such as a user equipment (UE)). The hardware platform 1200 includes at least one processor 1210 and a memory 1205 having instructions stored thereupon. The instructions upon execution by the processor 1210 configure the hardware platform 1200 to perform the operations described in FIGS. 1 to 10 in the various embodiments described in this patent document. The transmitter 1215 transmits or sends information or data to another device. For example, a network device transmitter can send a message to a user equipment. The receiver 1220 receives information or data transmitted or sent by another device. For example, a user equipment can receive a message from a network device.

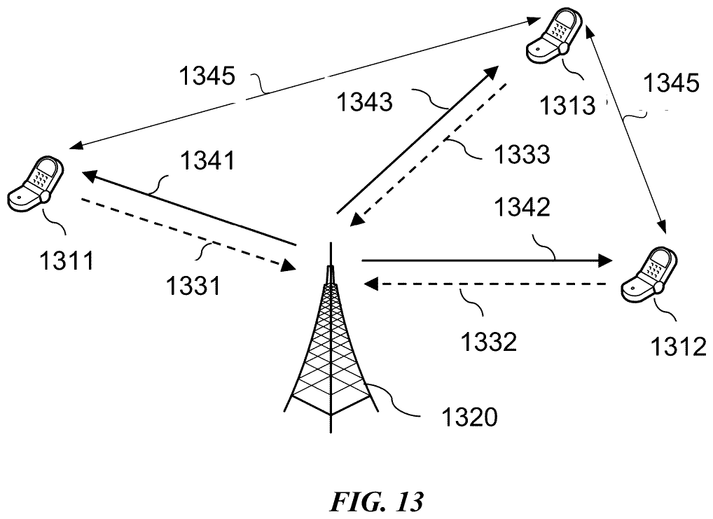

FIG. 13 shows an example of a wireless communication system (e.g., a 5G or NR cellular network) that includes a base station 1320 and one or more user equipment (UE) 1311, 1312 and 1313. In some embodiments, the UEs access the BS (e.g., the network) using a communication link to the network (sometimes called uplink direction, as depicted by dashed arrows 1331, 1332, 1333), which then enables subsequent communication (e.g., shown in the direction from the network to the UEs, sometimes called downlink direction, shown by arrows 1341, 1342, 1343) from the BS to the UEs. In some embodiments, the BS send information to the UEs (sometimes called downlink direction, as depicted by arrows 1341, 1342, 1343), which then enables subsequent communication (e.g., shown in the direction from the UEs to the BS, sometimes called uplink direction, shown by dashed arrows 1331, 1332, 1333) from the UEs to the BS.

For all of the foregoing cases the following can apply. a) ProSe-MAC-I derivation can used for UE to verify the information is not tampered. b) The AUSF or the PAnF may also generate a Prose-MAC-I. The parameter is generated based on the Prose key, a Counter, the prose data. If the Prose-MAC-I is generated by the PAnF, the Prose-MAC-I is sent from PAnF to AUSF. c) The Prose key can be 5GPRUK, K_{AUSF_P} (generated from prose authentication), K_{AUSF}(generated from primary authentication). d) The Prose data can be a refresh indication. e) The AUSF may sends a Prose-MAC-I to the Remote UE. The Remote UE will verify the Prose-MAC-I. If successful, the UE should accept the prose data, and if the prose data is a refresh indicator, the UE should generate the new 5GPRUK.

The following clauses reflect features of some preferred embodiments.

Clause 1. A method of wireless communication, comprising: generating, by an authentication node, a remote user key and a remote user key lifetime; sending, from the authentication node to an anchor function node, the remote user key and the remote user key lifetime; and sending the remote user key lifetime to a remote wireless device via a relay wireless device.

Clause 2. The method of wireless communication of clause 1, further comprising: receiving an identity of the remote user key; and forwarding the identity of the remote user key to the anchor function node.

Clause 3. The method of wireless communication of clause 2, wherein the anchor function node receives an identity of the remote user key, retrieves the remote user key, and check the whether the remote user key lifetime has expired

Clause 4. The method of wireless communication of clause 1, wherein a remote wireless device does not have a valid remote user key lifetime or the remote user key lifetime has expired, causing the remote wireless device to send a concealed identifier in a communication request to trigger a remote wireless device authentication procedure to cause generation of a new remote user key.

Clause 5. The method of wireless communication of clause 1, wherein an authentication server of a remote wireless device generates the remote user key lifetime.

Clause 6. The method of wireless communication of clause 1, wherein the anchor node function sends the user key lifetime to the authentication node.

Clause 7. The method of wireless communication of clause 1, wherein the authentication node generates a lifetime for a proximity service key and sends the lifetime of the proximity service key to the remote wireless device or a network relay.

Clause 8. The method of wireless communication of clause 1, wherein the remote wireless device stores the remote user key lifetime.

Clause 9. A method of wireless communication, comprising: determining, at an authentication node, to refresh a remote user key using the subscription permanent identifier; and determining to refresh the remote user key based on a policy local to the authentication node.

Clause 10. The method of wireless communication of clause 9, further comprising: receiving, at the authentication node from an anchor node function, the subscription permanent identifier.

Clause 11. The method of wireless communication of clause 9, wherein the authentication node sends a refresh request message including a remote user key identifier to the anchor node function.

Clause 12. The method of wireless communication of clause 9, wherein the authentication node uses the subscription identifier to get an authentication vector from a management node and trigger a remote wireless device authentication procedure to cause generation of a new remote user key.

Clause 13. A method of wireless communication, comprising: receiving, at an anchor node function from an authentication node, a key request for a remote user key including a identifier of the remote user key; determining, at the anchor node function, to refresh the remote user key which is retrieved using the identifier of the remote user key; and sending a subscription permanent identifier and a refresh indication to the authentication node.

Clause 14. The method of wireless communication of clause 13, wherein the authentication node uses the subscription identifier to get an authentication vector from a management node and to trigger a remote wireless device authentication procedure to cause generation of a new remote user key.

Clause 15. The method of wireless communication of clause 13, wherein the refresh indication is a message name or an indicator parameter.

Clause 16. The method of wireless communication of clause 13, wherein the anchor function node determines to refresh the remote user key based on a local policy of the anchor function node, including the remote user key lifetime.

Clause 17. A method of wireless communication, comprising: receiving, at an authentication node, a remote user key; determining, at the authentication node, to generate a new remote user key based on the received remote user key; registering the new remote user key based on the remote user key; and sending, a key refresh indication container to a remote wireless device.

Clause 18. The method of wireless communication of clause 17, wherein a new remote user key derivation parameter includes a key fresh indicator and a freshness parameter.

Clause 19. The method of wireless communication of clause 17, wherein the authentication node generates an authentication code based on the received remote user key and a counter.

Clause 20. A method of wireless communication, comprising receiving, at an authentication node, a remote user key or a remote user key identifier; determining, by the authentication node, to refresh the remote user key; and sending a refresh request message to an anchor node function

Clause 21. A method of wireless communication, comprising; receiving, at an anchor node function, a key request for a remote user key including a remote user key identifier; determining to generate a new remote user key based on the remote user key; and sending a key refresh indication container to an authentication node and to a remote wireless device.

Clause 22. The method of wireless communication of clause 21, wherein the anchor node determines to refresh the remote user key based on a local policy of the anchor node including a remote user key lifetime

Clause 23. The method of wireless communication of clause 21, wherein a refresh indication container sent from the authentication node to a mobility manager and used to generate the remote user key.

Clause 24. The method of wireless communication of clause 21, wherein the remote wireless device generates the new remote user key based on parameters in the key refresh indication container.

Clause 25. The method of wireless communication of clause 21, wherein the authentication node generates and sends the key refresh indication container to the remote wireless device.

Clause 26. The method of wireless communication of clause 21, wherein the key refresh indication container includes a key freshness parameter, a counter, a refresh indicator, and an authentication code.

Clause 27. The method of wireless communication of clause 21, wherein the remote wireless device generates an authentication code based on the received key refresh indication container and compares the generated authentication code and a received authentication code.

Clause 28. A method of wireless communication, comprising: receiving an authentication response message from a management node based in part on an authentication status stored at the management node; determining, by the first authentication node to refresh a remote user key based in part on a received subscription identifier; sending, by the first authentication node to the management node, a request message indicating a result and a time of an authentication procedure with a wireless device using and including a subscription identifier, a timestamp of the authentication, an authentication type and a serving network name; sending from the first authentication node to a second authentication node, a request message and receiving a response message; and generating, by the first authentication node, the remote user key based on an authentication key.

Clause 29. The method of wireless communication of clause 28, wherein the first authentication node receives the remote user key from a second authentication node.

Clause 30. A method of wireless communication, comprising: storing, at a management node, an authentication response message based in part on an authentication status; receiving a request message based in part on a determination by an anchor function node to refresh a remote user key; using a subscription identifier to determine a stored identifier at a first authentication node and sending a corresponding request to a second authentication node or to an anchor function node.

Clause 31. The method of wireless communication of clause 30, wherein the management node uses a subscription identifier to access the stored identifier and sends a request to the second authentication node.

Clause 32. The method of wireless communication of clause 30, wherein the management node uses a subscription identifier to access the stored identifier and sends a request to the anchor function node.

Clause 33. The method of wireless communication of clause 30, wherein the management node forwards the remote user key to the anchor function node.

Clause 34. The method of wireless communication of clause 30, wherein the second authentication node forwards the remote user key to the anchor function node.

Clause 35. The method of wireless communication of clause 30, wherein the anchor function node sends an authentication request message to the second authentication node and receives a response from the second authentication node.

Clause 36. The method of wireless communication of clause 30, wherein the anchor function node generates the remote user key based on another key and one or more parameters from a refresh indication container including one or more of a refresh indicator, a count, or a freshness parameter.

Clause 37. The method of wireless communication of clause 30, wherein the anchor function node a response message to the first authentication node including a new remote user key and a refresh indication container.

From the foregoing, it will be appreciated that specific embodiments of the presently disclosed technology have been described herein for purposes of illustration, but that various modifications may be made without deviating from the scope of the invention. Accordingly, the presently disclosed technology is not limited except as by the appended claims.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method of wireless communication, comprising;
receiving, at an anchor node function, a key request for a remote user key including a remote user key identifier;
determining to generate a new remote user key based on the remote user key; and
sending a key refresh indication container to an authentication node and to a remote wireless device.

2. The method of claim 1, comprising:
determining to refresh the remote user key based on a local policy of the anchor node including a remote user key lifetime.

3. The method of claim 1, wherein a refresh indication container is used to generate the remote user key.

4. The method of claim 1, wherein the key refresh indication container includes a key freshness parameter, a counter, a refresh indicator, and an authentication code.

5. The method of claim 1, wherein the key refresh indication container enables the remote wireless device to generate an authentication code and compares the authentication code and a received authentication code.

6. A method of wireless communication, comprising:
storing, at a management node, an authentication response message based in part on an authentication status;
receiving a request message based in part on a determination by an anchor function node to refresh a remote user key;
using a subscription identifier to determine a stored identifier at a first authentication node and sending a corresponding request to a second authentication node or to an anchor function node.

7. The method of claim 6, comprising:
accessing the stored identifier and sending a request to the second authentication node using the subscription identifier.

8. The method of claim 6, comprising:
accessing the stored identifier and sending a request to the anchor function node using the subscription identifier.

9. The method of claim 6, comprising:
forwarding the remote user key to the anchor function node.

10. The method of claim 9, wherein the second authentication node forwards the remote user key to the anchor function node.

11. A device of wireless communication, implemented as an anchor node function, comprising at least one processor that is configured to:
receive a key request for a remote user key including a remote user key identifier;
determine to generate a new remote user key based on the remote user key; and
send a key refresh indication container to an authentication node and to a remote wireless device.

12. The device of claim 11, wherein the at least one processor is configured to:
determine to refresh the remote user key based on a local policy of the anchor node including a remote user key lifetime.

13. The device of claim 11, wherein a refresh indication container is used to generate the remote user key.

14. The device of claim 11, wherein the key refresh indication container includes a key freshness parameter, a counter, a refresh indicator, and an authentication code.

15. The device of claim 11, wherein the key refresh indication container enables the remote wireless device to generate an authentication code and compares the authentication code and a received authentication code.

16. A device of wireless communication, implemented as a management node, comprising at least one processor that is configured to:
store an authentication response message based in part on an authentication status;
receive a request message based in part on a determination by an anchor function node to refresh a remote user key;
determine a stored identifier at a first authentication node using a subscription identifier and send a corresponding request to a second authentication node or to an anchor function node.

17. The device of claim 16, wherein the at least one processor is configured to:
access the stored identifier and sending a request to the second authentication node using the subscription identifier.

18. The device of claim 16, wherein the at least one processor is configured to:
access the stored identifier and sending a request to the anchor function node using the subscription identifier.

19. The device of claim 16, wherein the at least one processor is configured to:
forwarding the remote user key to the anchor function node.

20. The device of claim 19, wherein the second authentication node forwards the remote user key to the anchor function node.
